(19) United States
(12) Patent Application Publication
(10) Pub. No.: US 2021/0256465 A1
(43) Pub. Date: Aug. 19, 2021

(54) DELIVERY FRAMEWORK FOR ROBOTS

(71) Applicant: STARSHIP TECHNOLOGIES OÜ, Tallinn (EE)

(72) Inventor: Lauri VÄIN, Tallinn (EE)

(21) Appl. No.: 17/115,440

(22) Filed: Dec. 8, 2020

Related U.S. Application Data
(63) Continuation of application No. PCT/EP2019/065573, filed on Jun. 13, 2019.

(30) Foreign Application Priority Data
Jun. 13, 2018 (EP) 18177611.3

(51) Int. Cl. G06Q 10/08; G06Q 10/06

(52) U.S. Cl. CPC G06Q 10/0832; G06Q 10/06315; G06Q 10/0833; G06Q 10/08355

(57) ABSTRACT

A method for operating a framework comprising a plurality of robots is disclosed. The method comprises at least receiving a request for delivery, and selecting, from a subset of the plurality of robots, an appropriate robot to handle the delivery. A delivery framework comprising a plurality of robots and a backend platform is also disclosed.

### RELATED APPLICATIONS

This application is a continuation of PCT/EP2019/065573, filed Jun. 13, 2019, published as WO/2019/238865, and which claimed priority from European application no. 18177611.3 filed Jun. 13, 2018, the entire contents of both of which are hereby fully incorporated herein by reference for all purposes.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

This invention relates generally to robots, and, more particularly, to a framework for delivery robots.

### BACKGROUND

Robots have been developed to deliver goods. For example, STARSHIP TECHNOLOGIES OÜ has developed semi-autonomous delivery robots that can navigate sidewalks and roads to deliver goods and services to arbitrary locations.

In a typical scenario, a robot delivers goods to a chosen delivery location. The goods may already be in the robot or they may have to first be picked up.

In a system with multiple robots, more than one robot may be able to handle a particular delivery. It is therefore desirable to select, possibly from multiple robots, an appropriate robot to handle a particular delivery.

In the presence of multiple fleets of robots, it may be desirable and appropriate for robots from one fleet to handle deliveries for another fleet.

### SUMMARY

This object pertains to the present invention, which relates to a framework comprising a plurality of robots. This object is built upon the methodology outlined in the subject matter according to the claims and as further explained in detail below.

In a first embodiment, a method for operating a framework comprising a plurality of robots is disclosed. The method comprises receiving a request for a delivery, the request comprising an associated delivery location. The method also comprises selecting from a subset of the plurality of robots an appropriate robot to handle the delivery. The method further comprises executing the delivery. The selection of the appropriate robot is based at least on the delivery location and one or more subsequent locations the robot is to reach. The appropriate robot is one of the subset of the plurality of robots that has sufficient capacity to execute the request for a delivery and to reach the one or more subsequent locations.

The framework can refer to a combined software and hardware infrastructure system such as a server coordinating and controlling multiple robots.

Receiving a request for a delivery can be done via a communication protocol such as a user sending a request via an app-based or a web-based interface. In other words, a user might order an item (which may be consumable or not) via an app on their personal computing device (such as a smartphone or tablet).

Selecting from a subset of robots can comprise running an algorithm on a server to determine which robot (or robots) could perform the requested delivery and subsequently depart it without compromising their operation, an existing schedule of deliveries and/or other constraints.

Note, that executing the delivery can also comprise executing it via a robot from a second framework comprising a plurality of robots, different from the one coordinating the delivery request. In other words, in the absence of an appropriate robot from the framework, a partner framework can be tasked with executing the delivery.

Sufficient capacity for executing the delivery can refer to sufficient battery capacity of the robot, scheduling of other deliveries and/or other constrains.

The described method is particularly advantageous for coordinating and controlling multiple delivery robots based on incoming delivery requests and on the capacity of the set of robots.

In some embodiments, the selection of the appropriate robot can be further based on a configuration of the plurality of robots. In some such embodiments, the delivery can require a predetermined robot configuration, and the appropriate robot can further have the predetermined robot configuration required for the delivery. In some such embodiments, the predetermined robot configuration can comprise at least one or a combination of a robot configured for carrying temperature-sensitive goods, a robot configured for carrying a plurality of size-appropriate goods as part of different deliveries, a robot configured for carrying a limited number of predetermined goods, and a robot configured for preparing the goods during transport.

The configuration for carrying a limited number of predetermined goods can refer to, for example, the robot being configured with a plurality of slots particularly suitable to hold a certain standard size beverage or good. In this case, the robot may roam around a certain area offering the specific type of good (or goods) that it is carrying to potential users. Put differently, the configuration may allow the robot to carry items of one type (or a few types) that may be delivered to recipients on demand, and while supply lasts.

In other words, each robot can have a certain configuration making it particularly suitable to carry a specific sort of item. This configuration can be realized, for example, by providing an easy way of configuring a storage compartment in which the robot carries items to be delivered. For instance, the storage compartment can be easily replaceable. Embodiments with specific robot configuration can be particularly useful for coordinating different types of deliveries which might require specific conditions. For example, delivery of frozen goods may require a temperature-controlled compartment, while delivery of meals and beverages in one order may require compartments within the robot's storage space.

In some embodiments, the request for the delivery can further comprise a delivery type and the selection of the appropriate robot can be further based on the delivery type. The delivery type can comprise, for example, temperature sensitive goods, fragile goods, heavy goods or other specific type of goods which may need a specific robot (preferably with a specific configuration) to deliver them.

In some embodiments, the request for the delivery can further comprise a pickup location, and the appropriate robot can further have sufficient capacity to reach the pickup location followed by the delivery location and followed by the one or more subsequent locations. The pickup location can correspond to a location where a robot is loaded with an item to be returned (such as an unwanted item that a user had delivered and now wants to return to sender). In other words, a robot can be loaded with an item to be delivered, travel to the corresponding delivery location, and subsequently travel to another location to pick up an item to be returned. The robot can then travel to a hub or home base where it can be recharged and where any returns it may carry can be unloaded.

In some embodiments, the request for the delivery can comprise a request for a pickup of goods at the delivery location. That is, the delivery request itself can comprise a request for a robot to come by and pick up an item to be returned without delivering any items.

In some embodiments, the one or more subsequent locations can comprise at least one or more of a further delivery location, a hub, a pod, a servicing location, and a robot moving vehicle. That is, after executing the delivery, the robot can proceed to one of these locations. In the case of a further delivery location, the robot may proceed to deliver items to another recipient at a different delivery location or pick up items to be returned there. A hub can comprise a specialized space where robots can be stored, maintained, loaded with deliveries and/or unloaded after a return. A hub can comprise a space such as a storage container specially configured and optimized for robot operations. A pod can comprise a smaller hub. Generally it can house one or two robots and serve as a maintenance and storage location for them. A servicing location can be, for example, a business where the robot can be maintenance (for instance, its battery may be exchanged and/or recharged). A robot moving vehicle can comprise a mobile hub. That is, it can be a vehicle such as a van or a truck with space to store robots (in order to transport them quicker) and potentially items to be delivered.

In some embodiments, the plurality of robots can comprise a plurality of subsets of robots configured to handle different types of deliveries and wherein the method further comprises, before selecting the appropriate robot, selecting an appropriate subset. The subsets can be useful to quickly assign a large number of deliveries to various robots. For example, one subsets of robots can be configured for delivering meals and beverages. Another subset can be configured for delivering mail or packages.

In some embodiments, the subsets of robots can be dynamically updated. That is, some robots may be reassigned from one subset to another. This can be useful to quickly handle increased demand for a certain type of deliveries. For instance, if an increased demand for meal delivery is observed, the corresponding subset of robots can be increased in size.

In some such embodiments, the subsets of robots can be dynamically updated based on forecasted requests for deliveries. This can be particularly useful, as the resulting delivery time and the efficiency of the operation could be optimized.

In some such embodiments, the subsets of robots are updated based on forecasted deliveries at one or more locations. That is, if increased demand of a certain type of deliveries is associated with a particular area, the subset of robots configured to handle deliveries of this type can be sent close to this area in anticipation of demand. In this way, the framework operating mobile robots can be equipped to handle various “rush hours” for different types of deliveries in certain locations. For example, areas around college campuses can have increased demand for meals and beverages on evenings and weekends, and around various dates associated with an academic calendar (such as exams time). In anticipation of this increased demand, more robots can be configured to handle meal deliveries and sent to the campus area. In another example, residential neighborhoods can have decreased demand during working hours, when most people living there would be away from home. In response to this expected drop in demand for deliveries, the framework can reassign robots from the subset associated with this residential neighborhood to other locations and to be configured for other types of deliveries.

In some such embodiments, the subsets of robots can be updated based on prior demand for deliveries. In other such embodiments, the subsets of robots can be updated based on forecasted future demand for deliveries. In other words, demand for different types of deliveries at different times and in different neighborhoods can be analyzed and forecasted based on historical data. Furthermore, days of the week, seasons, weather, events, holidays and further parameters can be taken into account when forecasting future demand for deliveries.

The subsets can also be updated based on a combination of prior demand and forecasted future demand with corresponding weight associated to each. Furthermore, the subsets can also be updated based on prior and/or forecasted demand for deliveries requiring a particular robot configuration. In other words, if a demand for a specific configuration (such as a configuration configured to transport temperature sensitive deliveries) has been growing, more robots can be assigned this configuration. Additionally, if a demand for certain types of deliveries (such as groceries or meals) is forecasted to increase during certain peak hours of the day, the subsets can also be updated accordingly. Similarly, if a demand for certain types of goods has been declining, or is forecasted to decline, some robots may be moved from a subset supporting the configuration for this type of goods to a different one.

In some embodiments, the method can further comprise, in case no appropriate robot can be selected from the subset of the plurality of robots, requesting a robot from at least one other framework to execute the delivery. That is, a robot associated with another framework can be requested for use. The other framework may comprise a different collection of robots and/or a collection of different robots.

In some embodiments, the method can further comprise using prior requests for deliveries to forecast future demand for deliveries. As detailed above, this can be particularly advantageous to estimate the amount of deliveries that will be received and streamline the delivery process. Analogously, prior requests for deliveries requiring a particular robot configuration can be used to forecast future demand for deliveries requiring such a configuration.

In some embodiments, the method can further comprise transporting at least one of the plurality of robots to a certain location based on the forecasting of future demand for deliveries and/or based on forecasting of future demand for deliveries requiring at least one particular robot configuration.

In some such embodiments, the method can further comprise outfitting at least one robot with a predetermined robot configuration based on the forecasting of future demand for deliveries.

In some such embodiments, the method can further comprise loading at least one robot with certain goods based on the forecasting of future demand for deliveries.

In some such embodiments, the forecasting can be dynamically updated. This is also outlined above, and is particularly advantageous for catering specifically to different delivery request rush hours. For example, there may be increased requests for coffee and breakfast deliveries in the morning, and groceries deliveries in the evening. Additionally, there may be more requests for deliveries during the weekends in some areas, and during the week in others. Other parameters can also influence the forecasting.

In some such embodiments, the forecasting can be performed based on at least one of types of delivery requested, delivery locations, time of request for deliveries, day of request for deliveries, weather conditions at or around the delivery locations, events at or around the delivery locations.

Dynamic forecasting is additionally advantageous for users, as it results in shorter wait times for deliveries.

In another embodiment, a delivery framework is disclosed. The delivery framework comprises a plurality of robots and a backend platform comprising at least one processor and at least one database. The backend platform is configured for receiving a request for a delivery, the request comprising an associated delivery location. It is also configured for selecting from a subset of the plurality of robots, an appropriate robot to handle the delivery. The selection is based at least on the delivery location and one or more subsequent locations the robot is to reach. The appropriate robot is one of the subset of the plurality of robots that has sufficient capacity to execute the request for a delivery and to reach the one or more subsequent locations.

In some embodiments, the delivery framework further comprises a frontend platform configured for communication between the framework and users requesting a delivery. The frontend platform can comprise an interface such as an app, a website, and/or another similar platform.

In some embodiments, the delivery framework can further comprise a robot storage facility comprising at least one of a hub, a pod, a servicing location, and a robot moving vehicle. These storage facilities are further described above and below.

In some such embodiments, the storage facility can be configured to at least one of storing the plurality of robots, maintaining the plurality of robots, servicing the plurality of robots, and loading the plurality of robots with goods. Maintaining and servicing may comprise battery charging and/or swapping, calibration of sensors, running diagnostic tests, inspecting the robots visually and otherwise and further services.

In some embodiments, each of the plurality of robots comprises a predetermined robot configuration. In some such embodiments, the predetermined robot configuration can comprise at least one of a robot configured for carrying temperature-sensitive goods, a robot configured for carrying a plurality of size-appropriate goods as part of distinct deliveries, a robot configured for carrying a limited number of predetermined goods, and a robot configured for preparing the goods during transport. The configurations may include passive or active cooling or heating elements, insulation, inbuilt beverage or food preparation components and/or compartments of varying size.

In some embodiments, the backend platform can be further configured to forecast demand for deliveries. In some such embodiments, the forecasting can be based on at least one of types of delivery requested, delivery locations, time of request for deliveries, day of request for deliveries, weather conditions at or around the delivery locations, and events at or around the delivery locations. For example, there may be more demand for meal delivery during rain or snow, as well as in areas around open air festivals, sports events or the like.

In some such embodiments, the backend platform can be further configured to determine preferred robot configurations based on the forecasting. For example, the backend can determine whether more robots need to be configured for meals deliveries versus package deliveries.

According to another aspect, the present invention pertains to a method to control and/or monitor a framework comprising a plurality of robots. The robots can be used as delivery robots that are especially adept, for instance, at navigating on walkways.

The method can comprise a response to a request for a delivery. A delivery location can be provided as one or more hubs on a route. The associated delivery location can be one or more that is/are closest, or that can provide goods and services needed for the next delivery or deliveries. The method can further comprise the step of selecting from a subset of the plurality of robots an appropriate robot to handle the delivery. The selection can be based on the delivery location(s), wherein said appropriate robot is one of said plurality of robots that can have sufficient capacity to carry out the delivery. The selected robot can have one or more possible end location(s), and the appropriate robot is one of the plurality of robots that has sufficient capacity to make the delivery and to reach one or more of the possible end location(s). The end location may or may not be the last delivery location.

The method can also comprise the selection based on a configuration of said robots. The configuration can, for example, be the type of mechanism or the size of the compartment the robot has. The method can also be based on the type of the delivery which can further decide the appropriate robot best configured for this delivery.

The method can also comprise the step of requiring a pickup associated with said delivery at one pickup location. The selection of the appropriate robot can be based on the said pickup location. This can be decided on the basis of the geography of the region of the pickup location and/or by the distance to the pickup location. The appropriate robot is one of the plurality of robots that has enough capacity to enable the pickup at the pickup location and to assure the delivery reaches one or more of the possible end locations, for example enabled by enough power in the battery.

The delivery can comprise the delivery of goods and/or provision of at least one service, for example delivering some coffee at the doorstep. The provision of the service can also comprise a pickup associated with delivery at the delivery location.

The method can further comprise selection of one or more possible end location(s) from a hub, a pod, a maintenance location, a battery changing location, and/or a robot carrying vehicle which comprises a subset with fewer than said plurality of robots. It can be easily understood by a skilled person that the plurality of robots can comprise one or more group or groups, and that the aforementioned subset can comprise at least one of said one or more group(s) of robots.

A hub may include multiple pods and can also be used for the storage of good(s) before their delivery(/ies). A maintenance location can store and maintain robots by replacing or servicing part(s) of the robot(s), such as wheels, batteries or the like. The maintenance location can also comprise the battery changing location and/or the robot carrying vehicle can comprise the maintenance location.

The method can further comprise formation of one or more delivery-type based groups where a membership and/or assignment of robots of at least one of the individual robots or robot group(s) is dynamic. The membership of at least one of the one or more group(s) can be based on prior delivery(ies) and/or expected or predicted deliveries at one or more locations, during one or more time periods, popularity of prior deliveries and/or expected or predicted popularity of future deliveries. The membership of at least one robot can also be changed. At least one of the robots can be a member of multiple groups.

The delivery can comprise delivery of a consumable good or goods. The method can further comprise an attempt to perform said delivery after the said attempt of selection has been successful. In response to a successful delivery said appropriate robot can travel to one of said individual or multiple possible end location(s) and/or other delivery location(s). When there is a failure in attempt of selection then an attempt can be made to obtain the robot from at least one other framework to handle the delivery. The method can further comprise of one or more bid(s). Each of one or more bids can comprise information about a corresponding robot. Each of said one or more bids can comprise an offer to perform said delivery and/or a cost for performing the delivery.

The method can further comprise the step of selecting a particular bid of the one or more bids to handle said delivery causing said delivery to be made based on said one particular bid. The method can comprise the step of selecting on the basis of the cost associated with candidate robots of said framework and/or on the prior relationship or arrangement between said framework and said at least one other framework making said bids. The said request can originate from another framework. The method can further comprise providing a bid to said other framework when the said attempt to select has been successful. Further, the bid can comprise information about one or more candidate robots to handle the delivery. The appropriate robot and/or can also comprise a cost for performing said delivery. The bid can also comprise an expiration time. The method of making the bids can be based on a prior relationship or arrangement between the framework and at least one other framework from which the request has been received.

In other aspect, the method can comprise a request for a delivery having an associated delivery location. The selection of the appropriate robot from the plurality can be based on at least one of said delivery location. The selected appropriate robot can be a particular robot in said fleet of robots that has sufficient capacity to make said delivery. Each fleet of said at least one fleet of robots can be associated with a corresponding delivery framework. When a first request is from a first delivery framework the said appropriate robot can be selected which can be the robot in a fleet associated with said first delivery framework. The method can comprise selection of a robot when the said appropriate robot is a robot in a second fleet associated with a second delivery framework which is distinct from said first delivery framework. This selection can be done based on information from said second delivery framework.

Also, the appropriate robot can be selected based on at least one offer from the said second delivery framework. In some embodiments the appropriate robot is selected based on the information and/or offers from the multiple delivery framework.

The method can further comprise instructing the appropriate robot to perform the delivery. The appropriate robot can be chosen on the basis of size, functionality, travel time, and/or cost related to the delivery etc. The offer can be made on the basis of the prior relationship or arrangement between said delivery frameworks. Further, the method can comprise compensation of the delivery framework associated with the appropriate robot delivering consumable good(s). In some aspects, service(s) can also be delivered. The method can comprise a pickup of at least one at said delivery location of the service(s) and/or good(s).

The method can also comprise the step of storing the information about deliveries requested or performed by a fleet of robots which help the robot(s) or the fleet to one or more particular location based on said information. The stored information can comprise historic information about prior deliveries requested or performed by said fleet of robots. When the robot(s) perform(s) deliveries said information comprises information about deliveries requested or performed by at least one other fleet of robots. It is to be noted that at least one other fleet of robots can be associated with at least one other framework. The said information can be the real-time information about requested deliveries. The method can also comprise of the movement of at least some robots done in anticipation of and prior to expected or predicted future requests. For example, if the said stored historic information shows demand for pizza deliveries every Thursday night at 11 PM in a particular location, then the said prediction mechanism may provide a fleet of appropriately configured robots at a suitable location to handle the demand.

The movement of the robots can comprise migration of at least some of said at least some robots, where migration can comprise setting end locations associated with one or more deliveries to said one or more particular locations. The method further can comprise setting end locations associated with one or more deliveries to said one or more particular locations. The set end location may be dependent on other factors. For example, after a certain time, it can be more convenient to have robots end their deliveries at hubs or maintenance stations or at pickup locations for a robot-carrying vehicle.

The method can further comprise transportation of at least some of said robots to said one or more particular locations using one or more robot-carrying vehicles. The configuration of at least some of the robots can be based on the said information, where configuring can comprise pre-configuring said at least some robots to handle certain kinds of deliveries. Configuration can be for example, an appropriate storage unit (e.g., heated, refrigerated, etc.), sufficient consumables (e.g., coffee, water, milk, cups, etc.). It can be noted here that the configuration can be performed before and/or during the moving. For example, a particular delivery robot may be configured to carry goods in a storage region and may also be configured to carry goods in a specialized storage unit and may also be configured to carry a preparation mechanism. The configuration can be based on inserting and/or removing a storage container from some of said at least some robots. The method can further comprise replacing the part(s) and/or charging the battery(s) for at least some robots during and/or prior to said moving. The start, pickup, and/or end locations maybe arbitrary locations and can include pods, hubs, maintenance units, and robot-carrying vehicles.

The method can comprise of a framework comprising of a plurality of robots; and a backend platform, said backend platform comprising one or more processors and one or more databases, wherein the backend is constructed and adapted to perform the method of any one of the aspects discussed above.

The present invention also relates to a system that comprises components that are configured to carry out the steps as described and claimed above and below.

The following numbered embodiments also form part of the invention.

Below is a list of method embodiments. Those will be indicated with a letter “M”. Whenever such embodiments are referred to, this will be done by referring to “M” embodiments.

M1. A method for operating a framework comprising a plurality of robots, the method comprising
receiving a request for a delivery, the request comprising an associated delivery location;
selecting from a subset of the plurality of robots an appropriate robot to handle the delivery; and
executing the delivery;
wherein the selection is based at least on the delivery location and one or more subsequent locations the robot is to reach;
wherein the appropriate robot is one of the subset of the plurality of robots that has sufficient capacity to execute the request for a delivery and to reach the one or more subsequent locations.

M2. The method according to the preceding embodiment wherein the selection of the appropriate robot is further based on a configuration of the plurality of robots.

M3. The method according to the preceding embodiment wherein the delivery requires a predetermined robot configuration, and wherein the appropriate robot further has the predetermined robot configuration required for the delivery.

M4. The method according to the preceding embodiment wherein the predetermined robot configuration comprises at least one or a combination of
a robot configured for carrying temperature-sensitive goods;
a robot configured for carrying a plurality of size-appropriate goods as part of distinct deliveries;
a robot configured for carrying a limited number of predetermined goods;
a robot configured for preparing the goods during transport.

M5. The method according to any of the preceding embodiments wherein the request for the delivery further comprises a delivery type and wherein the selection of the appropriate robot is further based on the delivery type.

M6. The method according to any of the preceding embodiments wherein the request for the delivery further comprises a pickup location, and wherein the appropriate robot further has sufficient capacity to reach the pickup location followed by the delivery location and followed by the one or more subsequent locations.

M7. The method according to any of the preceding embodiments wherein the request for the delivery comprises a request for a pickup of goods at the delivery location.

M8. The method according to any of the preceding embodiments wherein the one or more subsequent locations comprises at least one or more of
a further delivery location;
a hub;
a pod;
a servicing location; and
a robot moving vehicle.

M9. The method according to any of the preceding embodiments wherein the plurality of robots comprises a plurality of subsets of robots configured to handle different types of deliveries and wherein the method further comprises, before selecting the appropriate robot, selecting an appropriate subset.

M10. The method according to the preceding embodiment wherein the subsets of robots are dynamically updated.

M11. The method according to the preceding embodiment wherein the subsets of robots are dynamically updated based on forecasted requests for deliveries.

M12. The method according to any of the three preceding embodiments wherein the subsets of robots are updated based on forecasted deliveries at one or more locations.

M13. The method according to any of the four preceding embodiments wherein the subsets of robots are updated based on prior demand for deliveries.

M14. The method according to any of the five preceding embodiments wherein the subsets of robots are updated based on forecasted future demand for deliveries.

M15. The method according to any of the two preceding embodiments wherein the subsets of robots are updated based on at least one of prior and forecasted demand for deliveries requiring a particular robot configuration.

M16. The method according to any of the preceding embodiments further comprising, in case no appropriate robot can be selected from the subset of the plurality of robots, requesting a robot from at least one other framework to execute the delivery.

M17. The method according to any of the preceding embodiments further comprising using prior requests for deliveries to forecast future demand for deliveries.

M18. The method according to any of the preceding embodiments further comprising using prior requests for deliveries to forecast future demand for deliveries requiring at least one particular robot configuration.

M19. The method according to any of the two preceding embodiments further comprising transporting at least one of the plurality of robots to a certain location based on at least one of the forecasting of future demand for deliveries and the forecasting of future demand for deliveries requiring at least one particular robot configuration.

M20. The method according to any of the three preceding embodiments further comprising outfitting at least one robot with a predetermined robot configuration based on the forecasting of future demand for deliveries.

M21. The method according to any of the four preceding embodiments further comprising loading at least one robot with certain goods based on the forecasting of future demand for deliveries.

M22. The method according to any of the five preceding embodiments wherein the forecasting is dynamically updated.

M23. The method according to the preceding embodiment wherein the forecasting is performed based on at least one of
types of delivery requested;
delivery locations;
time of request for deliveries;
day of request for deliveries;
weather conditions at or around the delivery locations;
events at or around the delivery locations.

Below is a list of system embodiments. Those will be indicated with a letter “S”. Whenever such embodiments are referred to, this will be done by referring to “S” embodiments.

S24. A delivery framework comprising
a plurality of robots; and
a backend platform comprising at least one processor and at least one database;
wherein the backend platform is configured for
   receiving a request for a delivery, the request comprising an associated delivery location; and
   selecting from a subset of the plurality of robots, an appropriate robot to handle the delivery;
wherein the selection is based at least on the delivery location and one or more subsequent locations the robot is to reach;
wherein the appropriate robot is one of the subset of the plurality of robots that has sufficient capacity to execute the request for a delivery and to reach the one or more subsequent locations.

S25. The delivery framework according to the preceding embodiment further comprising a frontend platform configured for communication between the framework and users requesting a delivery.

S26. The delivery framework according to any of the preceding framework embodiments further comprising a robot storage facility comprising at least one of
a hub;
a pod;
a servicing location; and
a robot moving vehicle.

S27. The delivery framework according to the preceding embodiment wherein the storage facility is configured to at least one of
storing the plurality of robots;
maintaining the plurality of robots;
servicing the plurality of robots;
loading the plurality of robots with goods.

S28. The delivery framework according to any of the preceding framework embodiments wherein each of the plurality of robots comprises a corresponding robot configuration.

S29. The delivery framework according to the preceding embodiment wherein the robot configuration comprises at least one of
a robot configured for carrying temperature-sensitive goods;
a robot configured for carrying a plurality of size-appropriate goods as part of different deliveries;
a robot carrying predetermined goods;
a robot configured for preparing the goods during transport.

S30. The delivery framework according to any of the preceding framework embodiments wherein the backend platform is further configured to forecast demand for deliveries.

S31. The delivery framework according to the preceding embodiment wherein the forecasting is based on at least one of
types of delivery requested;
delivery locations;
time of request for deliveries;
day of request for deliveries;
weather conditions at or around the delivery locations;
events at or around the delivery locations.

S32. The delivery framework according to any of the two preceding embodiments wherein the backend platform is further configured to determine preferred robot configurations based on the forecasting.

Below is a list of further method embodiments. Those will be indicated with a letter “N”. Whenever such embodiments are referred to, this will be done by referring to “N” embodiments.

N1.. A method, in a framework comprising a plurality of robots, the method comprising:
in response to a request for a delivery, said delivery having an associated delivery location,
attempting to select, from a subset of said plurality of robots, an appropriate robot to handle the delivery, said selection being based on said delivery location,
wherein said appropriate robot is one of said plurality of robots that has sufficient capacity to make said delivery.

N2. The method of embodiment N1, wherein said selection is also based on one more possible end locations, and wherein said appropriate robot is one of said plurality of robots that has sufficient capacity to make said delivery and to reach one of said one or more possible end locations

N3. The method of embodiments N1 or N2, wherein said attempting to select is based on a configuration of said robots.

N4. The method of any one of the preceding embodiments, wherein said delivery has a delivery type and wherein said attempting to select is based on said delivery type.

N5. The method of any one of the preceding embodiments, wherein the delivery requires a pickup associated with said delivery at at least one pickup location, and wherein said attempting to select is based on said at least one pickup location, and wherein said appropriate robot is one of said plurality of robots that has sufficient capacity to make said pickup at at least one pickup location, and to make said delivery, and to reach one of said one or more possible end locations.

N6. The method of any one of the preceding embodiments, wherein said delivery requires a certain robot configuration, and wherein said attempting to select is based on configuration of at least some of said plurality of robots, and wherein an appropriate robot is a robot having said certain configuration.

N7. The method of any one of the preceding embodiments, wherein said delivery location is one of said one or more possible end locations.

N8. The method of any one of the preceding embodiments, wherein said delivery comprises the delivery of goods.

N9. The method of any one of the preceding embodiments, wherein said delivery comprises the provision of at least one service.

N10. The method of embodiment N9, wherein the provision of said at least one service comprises a pickup associated with said delivery at said delivery location.

N11. The method of any one of the preceding embodiments, wherein said one or more possible end locations are selected from: a hub, a pod, a maintenance location, a battery changing location, and a robot-carrying vehicle.

N12. The method of any one of the preceding embodiments, wherein said subset comprises fewer than said plurality of robots.

N13. The method of any one of the preceding embodiments, wherein said plurality of robots comprise one or more groups, and wherein said subset comprises at least one of said one or more groups.

N14. The method of embodiment N13, wherein at least one of the one or more groups is formed to handle a particular type of delivery.

N15. The method of embodiment N13, wherein membership of at least one of the one or more groups is dynamic.

N16. The method of embodiments N13 or N15, wherein assignment of robots to at least one of the one or more groups is dynamic.

N17. The method of any one of the embodiments N13-16, wherein membership of at least one of the one or more groups is based on prior deliveries.

N18. The method of any one of the embodiments N13-17, wherein membership of at least one of the one or more groups is based on expected or predicted deliveries.

N19. The method of embodiment N18, wherein membership of at least one of the one or more groups is based on expected or predicted deliveries at one or more locations.

N20. The method of embodiments N18 or N19, wherein membership of at least one of the one or more groups is based on expected or predicted deliveries during one or more time periods.

N21. The method of any one of embodiments N13-20, wherein membership of at least one of the one or more groups is based on popularity of prior deliveries.

N22. The method of any one of embodiments N13-21, wherein membership of at least one of the one or more groups is based on expected or predicted popularity of future deliveries.

N23. The method of any one of embodiments N13-22, wherein the group membership of at least one robot is changed.

N24. The method of any one of embodiments N13-23, wherein at least one robot is a member of multiple groups.

N25. The method of any one of the preceding embodiments, wherein said delivery comprises delivery of a consumable good.

N26. The method of any one of the preceding embodiments, further comprising:
in response to said attempting to select being successful, attempting to perform said delivery.

N27. The method of any one embodiments N2-26, further comprising:
in response to said delivery being successfully made, said appropriate robot travelling to one of said one or more possible end locations.

N28. The method of any one of the preceding embodiments further comprising:
attempting to obtain a robot from at least one other framework to handle said delivery.

N29. The method of embodiment N28, wherein said attempting to obtain is performed in response to failure of said attempting to select.

N30. The method of embodiments N28 or N29, wherein said attempting to obtain further comprises:
obtaining, from said at least one other framework, one or more bids to handle said delivery.

N31. The method of embodiment N30, wherein each of said one or more bids comprises information about a corresponding robot.

N32. The method of embodiments N30 or N31, wherein each of said one or more bids comprises an offer to perform said delivery.

N33. The method of any one of embodiments N30-32, wherein each of said one or more bids comprises a cost for performing said delivery.

N34. The method of any one of embodiments N30-33, further comprising:
selecting a particular bid of said one or more bids to handle said delivery.

N35. The method of embodiment N34, further comprising:
causing said delivery to be made based on said one particular bid.

N36. The method of embodiments N34 or N35, wherein said selecting is based on a cost associated with at least some of said one or more bids.

N37. The method of embodiment 36, wherein said selecting is also based on a cost associated with candidate robots of said framework.

N38. The method of any one of embodiments N34-37, wherein said selecting is also based on a prior relationship or arrangement between said framework and said at least one other framework making said bids.

N39. The method of any one of the preceding embodiments wherein said request originates from another framework.

N40. The method of embodiment N39, further comprising:
in response to said attempting to select being successful, providing a bid to said other framework.

N41. The method of any one of embodiments N40, wherein said bid comprises information about one or more candidate robots to handle said delivery.

N42. The method of any one of embodiments N40-41, wherein said bid comprises information about said appropriate robot.

N43. The method of embodiments N40-42, wherein said bid comprises an offer to perform said delivery.

N44. The method of any one of embodiments N40-43, wherein said bid comprises a cost for performing said delivery.

N45. The method of any one of embodiments N40-44, wherein said bid comprises an expiration time.

N46. The method of any one of embodiments N40-45, wherein said bid is made based on a prior relationship or arrangement between said framework and at least one other framework.

N47. The method of any one of embodiments N40-46, wherein said bid is made based on a prior relationship or arrangement between said framework and said other framework from which the request came.

N48. A method comprising:
in response to a request for a delivery, said delivery having an associated delivery location,
selecting, from at least one fleet of robots, an appropriate robot to handle the delivery, said selection being based at least on said delivery location,
wherein said appropriate robot is a particular robot in said at least one fleet of robots that has sufficient capacity to make said delivery.

N49. The method of embodiment N48, wherein said at least one fleet of robots comprises multiple distinct fleets of robots.

N50. The method of embodiments N48 or N49, wherein each fleet of said at least one fleet of robots is associated with a corresponding delivery framework.

N51. The method of any one of embodiments N48-N50, wherein said request is from a first delivery framework, and wherein said appropriate robot is a robot in a fleet associated with said first delivery framework.

N52. The method of any one of embodiments N48-N50, wherein said request is from a first delivery framework and wherein said appropriate robot is a robot in a second fleet associated with a second delivery framework, distinct from said first delivery framework.

N53. The method of embodiment N52, wherein the appropriate robot is selected based on information from said second delivery framework.

N54. The method of embodiments N52 or N53, wherein the appropriate robot is selected based on at least one offer from said second delivery framework.

N55. The method of embodiment N47, wherein the appropriate robot is selected based information from multiple delivery frameworks.

N56. The method of any one of embodiments N52-55, wherein the appropriate robot is selected based on offers from multiple delivery frameworks.

N57. The method of any one of embodiments N48-56, further comprising:
causing the appropriate robot to perform the delivery.

N58A. The method of embodiment N57, wherein said causing comprises: instructing the appropriate robot to perform the delivery.

N59B. The method of embodiments N57 or N58A, wherein said causing comprises:
the appropriate robot performing the delivery.

N60. The method of any one of embodiments N50-59, wherein said at least one offer is made based on a prior relationship or arrangement between said delivery frameworks.

N61. The method of any one of embodiments N54-60, wherein said at least one offer was made based on a prior relationship or arrangement between said first delivery framework and said second delivery framework.

N62. The method of any one of embodiments N48-61, further comprising:
compensating the delivery framework associated with the appropriate robot.

N63. The method of any one of embodiments N48-62, wherein said delivery comprises the delivery of goods.

N64. The method of embodiment N63, wherein said delivery comprises delivery of a consumable good.

N65. The method of any one of embodiments N48-64, wherein said delivery comprises the provision of at least one service.

N66. The method of embodiment N65, wherein the provision of said at least one service comprises a pickup of at least one at said delivery location.

N67. A method comprising:
maintaining information about deliveries requested or performed by a fleet of robots;
moving at least some robots in said fleet of robots to one or more particular locations based on said information.

N68. A method comprising:
maintaining information about deliveries requested or performed by a fleet of robots;
causing at least some robots in said fleet of robots to move or be moved to one or more particular locations based on said information.

N69. The method of embodiments N67-68, wherein said information comprises historic information about prior deliveries requested or performed by said fleet of robots.

N70. The method of embodiments N57 or N58, wherein said information comprises popularity information associated with deliveries requested or performed by said fleet of robots.

N71. The method of any one of embodiments N68-70, wherein the information comprises information about deliveries requested or performed by at least one other fleet of robots.

N72. The method of embodiment N71, wherein said at least one other fleet of robots is associated with at least one other framework.

N73. The method of any one of embodiments N68-72, wherein the information comprises real-time information about deliveries.

N74. The method of any one of embodiments N68-73, wherein the information comprises real-time information about requested deliveries.

N75. The method of any one of embodiments N68-74, wherein said moving said at least some robots is done in anticipation of expected or predicted future delivery requests.

N76. The method of any embodiment N68-75, wherein said moving said at least some robots is done in anticipation of and prior to expected or predicted future delivery requests.

N77. The method of any one of embodiments N68-76, wherein said moving said at least some robots comprises:
migrating at least some of said at least some robots.

N78. The method of embodiment N77, wherein said migrating comprises:
setting end locations associated with one or more deliveries to said one or more particular locations.

N79. The method of any one of embodiments N68-78, wherein said moving said at least some robots comprises:
pre-positioning at least some of said at least some robots.

N80. The method of any one of embodiments N68-79, wherein said moving comprises:
transporting at least some of said at least some robots to said one or more particular locations using one or more robot-carrying vehicles.

N81. The method of any one of embodiments N68-80, further comprising:
configuring at least some robots based on said information.

N82. The method of embodiment N81, wherein said configuring comprises:
pre-configuring said at least some robots to handle certain kinds of deliveries.

N83. The method of embodiments N81 or N82, wherein said configuring is performed before said moving.

N84. The method of any one of embodiments N81-84, wherein, for at least some robots, said configuring is done during said moving.

N85. The method of any one of embodiments N81-85, wherein said configuring comprises inserting a storage container in some of said at least some robots.

N86. The method of any one of embodiments N81-85, wherein said configuring comprises removing a storage container from some of said at least some robots.

N87. The method of any one of embodiments N81-86, wherein said configuring comprises:
including goods in some of said at least some robots.

N88. The method of embodiment N87, wherein including said goods in some of said at least some robots comprises placing said goods in some of said at least some robots.

N89. The method of embodiments N87-88, wherein said goods comprise food or drink.

N90. The method of embodiment N89, wherein said food or drink are prepared.

N91. The method of embodiment N90, wherein said food or drink are ready for consumption.

N92. The method of any one of embodiments N67-91, further comprising:
replacing or charging a battery of at least some of said at least some robots.

N93. The method of embodiment N92, wherein, for at least some robots, said replacing or charging is performed, at least in part, during said moving.

N94. The method of embodiments N92 or N93, wherein, for at least some robots, said replacing or charging is performed, at least in part, prior to said moving.

N95. The method of any one of embodiments N67-94, wherein said one or more particular locations include at least one pod.

N96. The method of any one of embodiments N67-95, wherein said one or more particular locations include at least one hub.

N97. The method of any one of embodiments N67-96, wherein said one or more particular locations include at least battery changing unit.

Below is a list of framework embodiments. Those will be indicated with a letter “F”. Whenever such embodiments are referred to, this will be done by referring to “F” embodiments.

F1. A framework comprising:
a plurality of robots; and
a backend platform, said backend platform comprising one or more processors and one or more databases,
wherein the backend is constructed and adapted to perform the method of any one of the preceding “N” method embodiments.

The aspects of the invention will now be described with reference to exemplary embodiment and with reference to the drawings. It is noted that this description is provided for illustrative purpose only and that it should not be construed to limit the scope of the invention.

### BRIEF DESCRIPTIONS OF THE DRAWINGS

Objects, features, and characteristics of the present invention as well as the methods of operation and functions of the related elements of structure, and the combination of parts and economies of manufacture, will become more apparent upon consideration of the following description and the appended claims with reference to the accompanying drawings, all of which form a part of this specification.

FIGS. 1, 2A-2C, and 3 depict aspects of a typical delivery robot for use in a system according to exemplary embodiments hereof;

FIG. 4 shows an exemplary data structure storing robot status data according to embodiments hereof;

FIG. 5 depicts aspects of a delivery framework according to exemplary embodiments hereof;

FIG. 6 depicts aspects of a backend platform of a delivery framework according to exemplary embodiments hereof;

FIG. 7A depicts aspects of a data structure used by exemplary embodiments hereof;

FIGS. 8A-8B show various exemplary data structures according to exemplary embodiments hereof;

FIGS. 9A-9C depict aspects of operation of delivery frameworks according to exemplary embodiments hereof;

FIGS. 10A-10B are flowcharts showing operation of delivery frameworks according to exemplary embodiments hereof;

FIG. 11 depicts aspects of operation of multiple delivery frameworks according to exemplary embodiments hereof;

FIGS. 12A-12C are flowcharts showing operation of delivery frameworks according to exemplary embodiments hereof;

FIG. 13 depicts aspects of operation of delivery frameworks according to exemplary embodiments hereof;

FIG. 14 depicts aspects of computing according to exemplary embodiments hereof.

### DETAILED DESCRIPTION OF THE PRESENTLY PREFERRED EXEMPLARY EMBODIMENTS

### Glossary and Abbreviations

As used herein, unless used otherwise, the following terms or abbreviations have the following meanings:

A “mechanism” refers to any device(s), process(es), routine(s), service(s), or combination thereof. A mechanism may be implemented in hardware, software, firmware, using a special-purpose device, or any combination thereof. A mechanism may be integrated into a single device or it may be distributed over multiple devices. The various components of a mechanism may be co-located or distributed. The mechanism may be formed from other mechanisms. In general, as used herein, the term “mechanism” may thus be considered to be shorthand for the term device(s) and/or process(es) and/or service(s).

The mobile delivery robots as described herein may be autonomous or semi-autonomous robots, and are preferably configured for ground-based travel. Note, that as used herein, the terms autonomous or semi-autonomous robot can be used to mean any level of automation depending, e.g., on the task that the robot is performing and/or on the environment in which the robot is operating. That is, the robot can be adapted to function autonomously or semi-autonomously for most tasks, but can also be remotely controlled for some other tasks. Then, the robot would be non-autonomous during the time it is controlled, and then autonomous and/or semi-autonomous again when it is no longer controlled.

For example, a robot may assume any of the levels of automation as defined by the Society of Automotive Engineers (SAE), that is, the following five levels:

Level 0—No Automation

Level 1—Driver Assistance

Level 2—Partial Automation

Level 3—Conditional Automation

Level 4—High Automation

Level 5—Full Automation

Although the SAE levels usually refer to vehicles such as cars, they may also be used in the context of mobile robots. That is, Level 0 may correspond to a remote terminal fully controlling the robot. Levels 1-4 may correspond to the remote terminal partially controlling the robot, that is, monitoring the robot, stopping the robot or otherwise assisting the robot with the motion. Level 5 may correspond to the robot driving autonomously without being controlled by a remote terminal such as a server or a remote operator. A robot operating at any level, including Level 3 (full automation) may still be in communication with a remote terminal and receive instructions at regular intervals.

In terms of the SAE levels described above, the term “autonomous” may refer to Level 5, and “semi-autonomous” may refer to Levels 2-4.

As should be appreciated, a particular robot may have or operate with different levels of autonomy at different times.

Other terms have their ordinary meaning unless otherwise defined.

### Description

Robots

An exemplary delivery robot according to embodiments hereof is described in PCT/EP2016/074620, titled “Method and system for autonomous or semi-autonomous delivery,” the entire contents of which are fully incorporated herein by reference for all purposes.

A delivery robot used in a robot delivery framework preferably includes some or all of the following properties:
a robot can travel (autonomously or semi-autonomously) between arbitrary start and end locations within a particular region; and
a robot can carry and/or deliver and/or provide at least some goods or services or kinds of goods or services.

As used herein, the term “goods” broadly includes any article or combination of articles, including anything tangible. Goods to be delivered may not be in their final delivery form when put into the robot. For example, the goods carried and delivered by a robot may be at least partially formed or packaged or pre-packaged before being put into the robot, or the goods may be created or assembled or formed while being put into the robot, or the goods may be created or assembled or formed in the robot (e.g., during a delivery phase).

The term “service” includes any kind of service (e.g., WiFi service, network connectivity, etc.) and may be provided alone or in combination with goods. The term “service” also includes a pickup service, e.g., where a robot is used to pick up something (e.g., goods) from one location for subsequent delivery or storage.

A robot can preferably deliver or provide different kinds of goods and/or services, and some of the goods and/or services may require special treatment or storage or the like (e.g., goods may have to be kept at certain temperatures, goods may be fragile, etc.) For example, when the goods are prepared or cooked food (e.g., pizza or coffee or soup), it may be desirable that the goods be kept or at least delivered warm. Similarly, some items are preferably kept or at least delivered cold (e.g., sodas, perishable goods, etc.).

As should be appreciated, the scope hereof is not limited by the kind(s) of goods and/or services that a robot can deliver or provide.

As used herein, the term “semi-autonomously,” when used in connection with a robot's actions, including its movement and/or navigation, means that the robot may act (e.g., travel between locations) without external supervision or assistance, but that it may get supervision or assistance for at least some of its actions or functionality, e.g., if needed. The inventions described herein are not limited by the degree of autonomy (or semi-autonomy) of any particular robot. It should be appreciated that a particular robot may perform a particular delivery without any external supervision or assistance and another delivery with some external supervision or assistance.

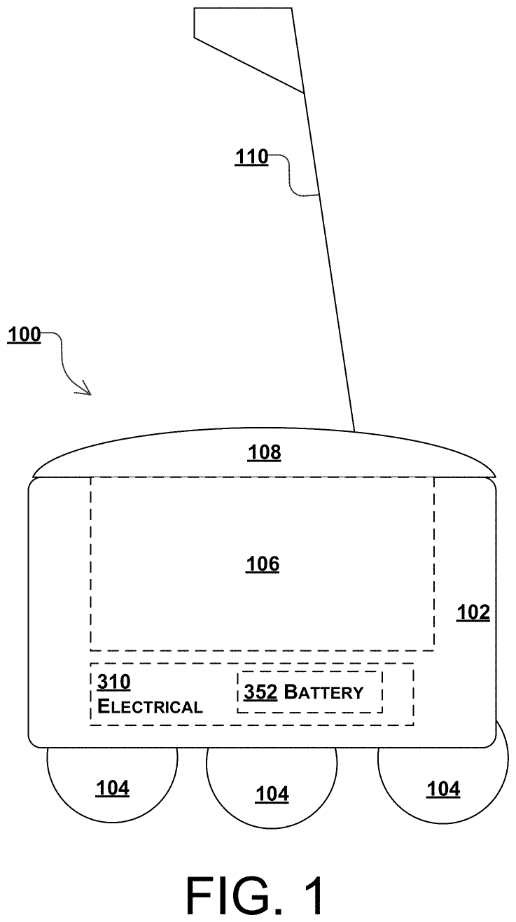

FIG. 1 shows a side view of an exemplary robot 100, showing aspects of the robot. With reference to FIG. 1, an exemplary robot 100 includes a robot body 102 supported and moved by a movement mechanism such as wheels 104. The drawing shows three wheels on one side of the robot, it being understood that there are also wheels on the other side of the robot. Preferably, the robot 100 comprises six wheels (that is, three on each side), but other configurations such as four, five or more wheels are also possible. Although the robot shown in FIG. 1 uses wheels for movement and support, other mechanisms may be used (alone or in conjunction with wheels). For example, a robot may use tracks, wheels, legs, rollers, or combinations thereof. The robot can also be equipped with removable/detachable wheels 104 to be able to make the storage easier and/or to change wheels, replace worn out wheels etc.

The robot 100 preferably includes at least one storage region 106 that can be used to store and carry goods for delivery. The storage region 106 may also contain mechanisms needed to provide services (e.g., WiFi access points, etc.) As should be appreciated, the storage region(s) 106 is (are) preferably inside the robot 100 (hence it is shown using dashed lines). The storage region(s) 106 can also be bigger to fit the size as of carrying unit 102 with battery(s) and electrical 310 in the same compartment. The storage region 106 can be modified to fit the size and nature of the package. The storage region (s) 106 can be equipped with heat/cold insulation. The carrying unit 102 preferable is manufactured from high density plastic to control the weight. Alternatively or additionally aluminum or any light weighted malleable metal can be used in other embodiments.

The robot 100 preferably includes a lid 108 or similar mechanism to provide access (preferably controlled) to the storage region(s) 106.

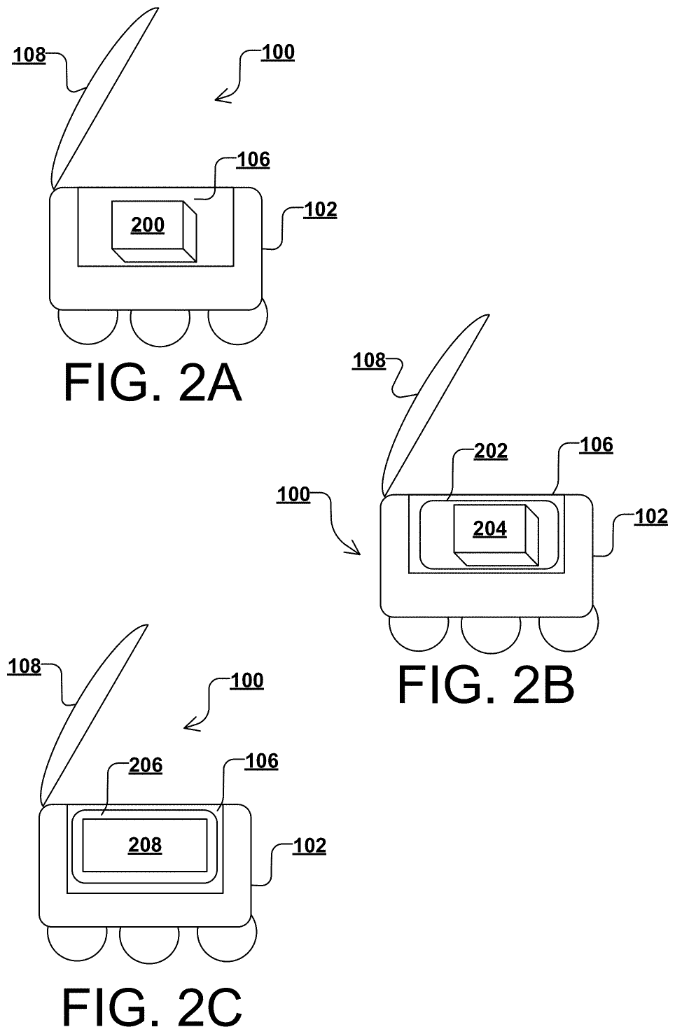

With reference to FIG. 2A, the lid 108 may be opened (e.g., via a hinge or the like) to provide access to goods 200 in the storage region 106. The lid 108 can be equipped with a locking mechanism for the security of the package(s). In FIG. 2A lid is shown to cover the whole carrying unit 102, in other embodiments it can also be provided to cover the storage region 106. The storage region 106 can be of different shapes, for example, rounded, squared, hexagonal etc. This can be used for a differently shaped package(s) 200.

In some cases, a specialized storage unit may be used (e.g., for heating or cooling the goods). For example, as shown in FIG. 2B, the storage region 106 may include a specialized storage unit 202 to provide storage for the goods 204. An exemplary specialized storage unit is described in U.S. application Ser. No. 15/808,152, the entire contents of which are fully incorporated herein by reference for all purposes.

A robot may be equipped or fitted with a preparation mechanism, e.g., to cook or heat or prepare food or the like during or at the time of delivery. For example, a robot may be equipped or fitted with a coffee preparation mechanism. FIG. 2C shows an exemplary robot 100 with a preparation mechanism 206 (e.g., a coffee preparation mechanism). The robot 100 may also include supplies 208 to be used by the preparation mechanism 206. For example, when the preparation mechanism 206 is a coffee preparation mechanism, the supplies 208 may include coffee beans, ground coffee, milk, water, and sugar. It is not only restricted to a coffee making mechanism, it can also be used for other mechanisms for example, the user can put the item with the cardboard, tapes and it can be packed within the robot. The preparation mechanism 206 can be equipped with a sorting mechanism to sort out the packages according to the receiver. The robot can be used as and/or a moving library. And the preparation mechanism 206 can be modified to sort the books/CDs based on genre or the like. The lid 108 can be provided with a LED to display which section of the storing unit 106 contains product to be taken.

The delivery robots are preferably configurable/customizable so as to meet various delivery requirements. For example, a particular delivery robot may be configured to carry goods in a storage region 106 (as shown in FIG. 2A) and may also be configured to carry goods in a specialized storage unit 202 (as shown in FIG. 2B), and may also be configured to carry and a preparation mechanism 206 and supplies 208 (as shown in FIG. 2C). The various mechanisms used to support different types of goods and services are preferably modular and constructed and adapted to fit within the storage region 106. It should be appreciated that a particular robot may be configured in a hybrid manner, e.g., with a specialized storage unit and a preparation mechanism. It should also be appreciated, however, that specialized robots may also be used for certain kinds of goods and/or services. For example, a non-modular robot with a particular mechanism (e.g., preparation or specialized storage) may also be used.

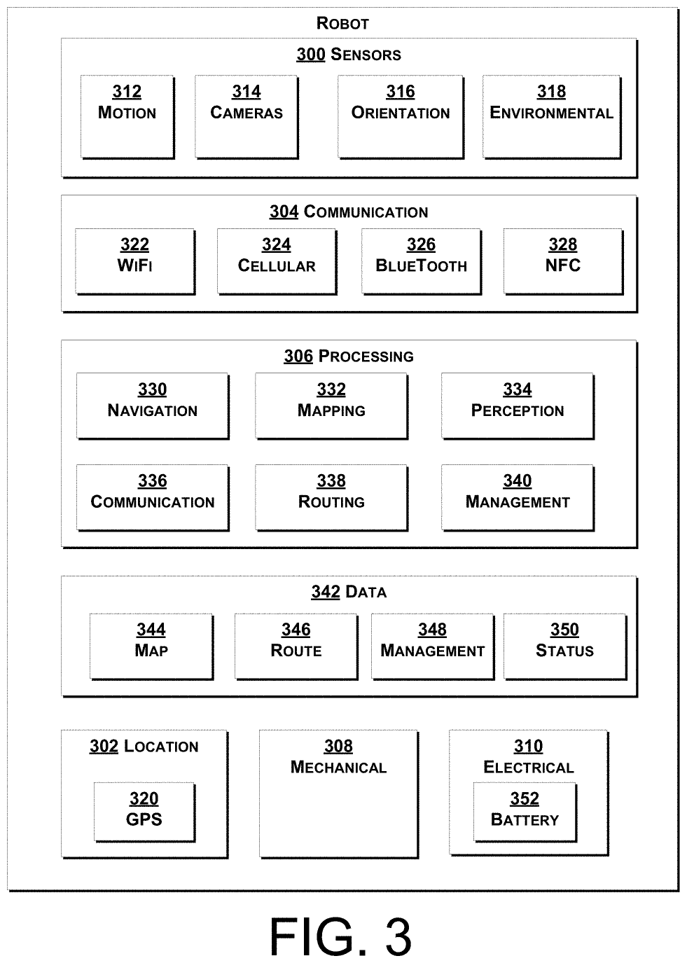

With reference to FIG. 3, an exemplary robot 100 preferably includes various sensors 300, location mechanism(s) 302, communication mechanism(s) 304, and processing mechanisms 306. The robot 100 also includes mechanical and electrical components 308, 310. Robot 100 can include the communication mechanism 304, the processing mechanism 306 and/or a database 342.

The sensors 300 may include one or more of the following: motion sensor(s) 312 (e.g., accelerometer(s), ultrasonic sensors, radars, and the like), cameras 314 (e.g. visual cameras, time of flight cameras, infrared cameras, and the like), orientation sensor(s) 316 (e.g., gyroscope(s)), and environmental sensor(s) 318 (e.g., temperature and/or humidity sensors).

The location mechanism(s) 302 preferably includes at least a satellite navigation system that provides or supports autonomous geo-spatial positioning with global coverage. The location mechanism(s) 302 may include mechanisms 320 supporting, e.g., GPS, GLONASS, Galileo, Beidou, and other regional systems.

The communication mechanism(s) 304 preferably include wireless communication mechanism(s) 322 (e.g., WiFi), and cellular communication mechanism(s) 324 (e.g., one or more cellular modems). The communication mechanism(s) 304 may also include short-range wireless communication mechanism(s) 326 (e.g., Bluetooth® or Zigbee or the like) and or near-field communication (NFC) mechanism(s) 328.

The processing mechanisms 306 may include mechanisms that provide and/or support the following functionality: navigation 330, for example, where the robot is present currently and where it needs to go. Mapping 332, can establish and/or complete and/or actualize an optimum path. Perception 334 of the information, communication 336 with the robot or the framework, can be done using radio signals, it will allow the robot to be in contact with the receiver and also will be easier for the control unit to know in case of mishaps. It can be short ranged using Bluetooth or the like or long range using satellite and/or CTI (computer telephony integration), where a telephone can be equipped on the robot 100. The processing mechanisms 306 may be implemented in hardware, software, firmware, or combinations thereof. The various listed processing mechanisms 306 and their logical organization is only exemplary, and different and/or other processing mechanisms may be included, having different and/or other logical organizations. The processing can be but is not restricted to be performed at the control system. Alternatively, it can be fitted in the robot. After the processing the data 342 can be used for the various aspects as mentioned in 342.

The various processing mechanisms 306 may include associated data 342. The various data 342 and their logical organization described here are only exemplary, and different and/or other data may be included, having different and/or other logical organizations. For example, the navigation mechanism 330 and the mapping mechanism 332 may use map data 344 and route data 346, and the management mechanism 340 may use management data 348.

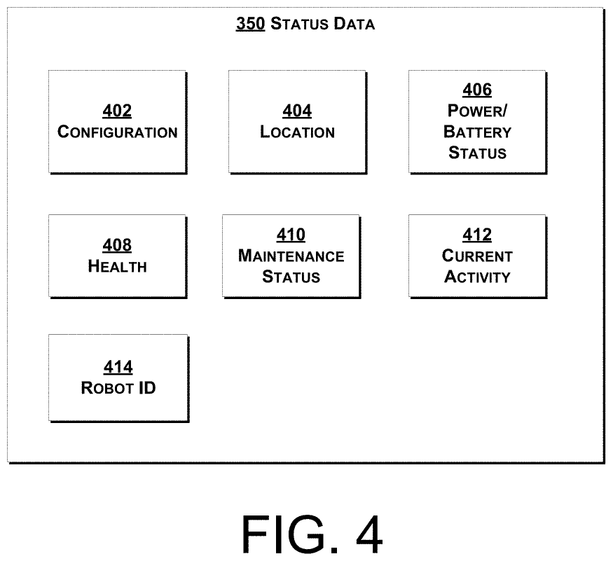

The robot 100 may also maintain status data 350 which, with reference to FIG. 4, may include information about the robot's configuration 402 (e.g., whether the robot has any specialized containers or mechanisms), current location 404, battery status 406 (e.g., remaining power, time since last charge, etc.), health 408, maintenance status 410 (e.g., time since last service, time till next service, etc.), and current activity 412 (e.g., waiting, on delivery, being maintained, charging battery, etc.). If on a delivery, the status data 350 may include information about the delivery contents, recipient and location. The status data can also be used by the receiver and/or the user to know the exact location 404 of the robot and how much time it will take for the package to be delivered. This can also provide information if the robot 100 is stuck. For example, in case there is a pedestrian and the robot needs to wait or slow down.

As explained below, the robot 100 preferably operates in a framework that may include one or more other components (e.g., pods, hubs, maintenance units such as battery changing units, and robot-moving/carrying vehicles). The robot's current location 404 may include an indication of whether the robot is currently in or on or associated with one or more of these other components.

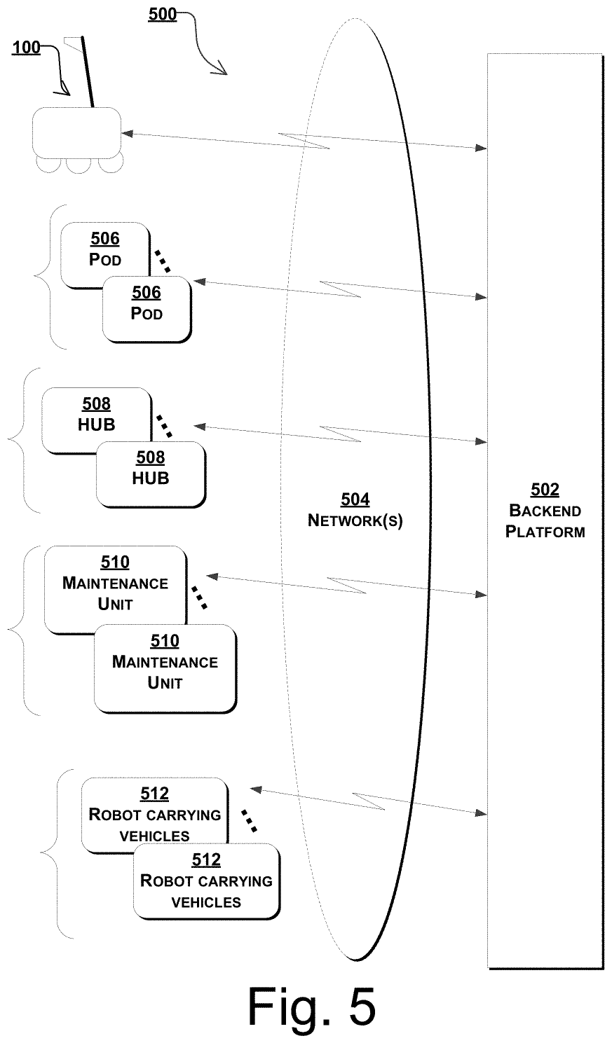

Each robot 100 preferably has a unique identifier 414 (e.g., a serial number or the like that is unique within a delivery framework 500, detailed below with reference to FIG. 5). This unique identifier may be stored alone or with the robot's configuration 402. The unique identifier Robot ID 414 maybe not be fixed to a robot but can be changed if the same robot is used in a different process. The Robot ID 414 can be task specified and/or size specified.

The listed configuration is exemplary, and different and/or other information may also be maintained.

Although shown here as having separate functionality, it should be appreciated that the various processing mechanisms 306 may interact and may overlap in implementation.

The mechanical and electrical components 308, 310 drive and power the robot 100, under the guidance and supervision of the processing mechanisms 306, possibly with external assistance (if needed and if the robot is not fully autonomous).

The electrical component(s) 310 preferably include one or more batteries 352 used to power the robot 100. The one or more batteries 352 are preferably rechargeable and replaceable. It is also not restricted to the use of one or more electric battery/ies, these can be solar. A solar panel can be placed on the robot. When the robot is waiting for the user it can switch to a standby mode. In this mode it can either save energy or if there is sun the solar panel can use the energy to charge the battery. An exemplary battery 352 is described in European patent application EP 17173111.0, the entire contents of which are fully incorporated herein by reference for all purposes.

With reference again to FIG. 1, a robot 100 preferably includes a flag 110 or the like to improve the robot's visibility. This flag can also be equipped with an antenna so it is more convenient to set up communication with the robot when it is needed.

Backend Platform

A delivery robot 100 operates in a delivery framework, in conjunction with other components, including a backend platform. For example, as shown in FIG. 5, a delivery framework or system 500 includes at least one delivery robot 100 (e.g., as described above) and a backend platform 502 (described in greater detail below). The robot 100 is preferably in communication with the backend platform 502 via one or more networks 504 (e.g., cellular networks, using the robot's cellular communications mechanism(s) 324). A particular robot may maintain constant connectivity with the backend platform 502, or it may maintain partial or intermittent connectivity with the backend platform 502. A robot may communicate directly and/or indirectly (e.g., via other robots, pods, hubs, maintenance units, robot-carrying vehicles, etc.) with the backend platform 502.

As explained below, the robot 100 may receive information from the backend platform 502, and may provide information to the backend platform, both via the one or more networks 504, and both directly and/or indirectly. For example, robot 100 may receive map and routing information and delivery or pickup instructions from the backend platform 502. The map and/or routing information may augment or replace map data 344 and route data 346 in the robot 100, and may be used by the robot's navigation mechanism(s) 330 for autonomous or semi-autonomous navigation. The delivery instructions may direct a robot, as described below, to a delivery location (possibly via a pickup location). This backend platform 502 can be the control system of the robot(s). This can recognize the robot(s) with their unique identification number Robot ID 414.

Information provided by the robot 100 to the backend platform 502 may include status information about the robot, e.g., some or all of the robot's status data 350 (described above with reference to FIG. 4). In some cases, the status information may comprise a heartbeat or the like from the robot. Status information and/or a heartbeat may be provided by the robot to the backend on a regular basis and/or on demand.

Although only one delivery robot is shown in FIG. 5, it should be appreciated that a particular delivery framework 500 preferably includes multiple robots. Although the robots preferably have the functionality and properties described above, there is no requirement that the delivery robots in a delivery framework 500 be homogenous or that they include all of the described functionality or properties. A delivery framework 500 can control one and/or more robot(s). One framework can also manage a few smaller framework(s). Frameworks can be subdivided on the basis of tasks or the like.

Although a delivery framework 500 may span multiple distinct and disjoint geographic regions, a particular delivery robot 100 typically operates in a particular geographic region (e.g., a city or town) or in a subset of the geographic regions covered by a backend platform. It should thus be appreciated that the backend platform 502 need not be in the same geographic location as all (or any) of the robots it controls, monitors, or supervises. Also, although shown in the drawing as one logical component, the backend platform 502 may be distributed functionally and geographically.

An exemplary delivery framework 500 may include various other components (at fixed locations or moving) that are considered part of the framework. These components may include one or more pods 506, one or more hubs 508, one or more maintenance units 510, and one or more robot-carrying vehicles 512. A pod 506 can store one or more robots, and pods may be used to house robots (e.g., as described in European patent application EP 17200025.9, the entire contents of which are fully incorporated herein by reference for all purposes). A hub 508 may include multiple pods. Hubs 508 may also be used to store goods before they are out for delivery via a robot 100 or after they are brought in by a robot 100 as part of a return procedure. An exemplary hub is described, for example in U.S. patent application Ser. No. 15/828,722, the entire contents of which are fully incorporated herein by reference for all purposes. A maintenance unit 510 may store and maintain a robot and may be used to replace or replenish or service parts of the robot. A maintenance unit 510 may also be used to replace or replenish operating components of a robot (e.g., coffee or water for a coffee making robot insert). For example, some maintenance units 510 may be used to automatically change or charge the batteries of a robot 100 (e.g., as described in EP 17173098.9, the entire contents of which are fully incorporated herein by reference for all purposes). These maintenance unit(s) 510 can also be equipped with communication devices 336 so they can contact the backend platform 502 in case something is needed to be fixed in the robot. For example, if there is a missing or broken wheel.

A robot-carrying vehicle 512 (or mothership) may be used to transport one or more robots from one location to another. The destination location of a robot-carrying vehicle 512 may be another location served by the delivery framework 500, or location served by a different delivery framework. A robot-carrying vehicle 512 may also include maintenance units, allowing robots to be maintained while being transported. For example, robot-carrying vehicle 512 may support cleaning, calibration, and battery changing, and other maintenance of robots it is transporting. In addition, a robot-carrying vehicle 512 may support configuration (or reconfiguration) of robots that it is carrying. For example, a robot-carrying vehicle 512 may support the configuration of a robot's storage unit or the like. In addition, in some cases, a robot-carrying vehicle 512 may support packing or restocking robots that it is carrying. A robot carrying vehicle can be equipped with a reader where it can identify from the data 350 the efficiency of the robot(s) and notify the backend platform 50) if it is not optimal. It can also be equipped with different shapes/sizes of storing unit(s) 106 so the robot(s) can be prepared for their next task accordingly, while they are being transported.

Exemplary robot-carrying vehicles 512 are described in PCT/EP2017/064019, PCT/EP2017/069723, PCT/EP2017/069727 PCT/EP2017/069729, the entire contents of each of which are fully incorporated herein by reference for all purposes.

Within the framework 500, a particular robot 100 may be located at a pod 506, a hub 508, a maintenance unit 510, on a robot-carrying vehicle 512, or at an arbitrary location. While a robot's location is preferably one from which it can navigate and move within the system, it should be appreciated that a robot may be in a location from which it cannot navigate or move (possibly even under external control or guidance). For example, a robot may reach a location by a particular path that then becomes blocked, or a robot may be moved (e.g., maliciously) to a location from which it cannot navigate or move. This sorting can also be done in the maintenance unit 510, for example, in a certain region robot(s) with tracks are better than robot(s) with wheels so they should be send out accordingly. The deciding factor can be the weather, geography and the like.

When a robot is associated with a component (pod 506, hub 508, maintenance unit 510, or robot-carrying vehicle 512), the robot may also communicate directly with that component. For example, a robot may communicate directly with a battery changing maintenance unit 510 while in the process of having its battery replaced. However, communication between the robot 100 and the various components may also be done via other components of the delivery framework 500.

Each of the components (pods 506, hub(s) 508, maintenance unit(s) 510, and robot-carrying vehicle(s) 512) is preferably in communication with the backend platform 502, and each of the components preferably informs the backend of its status and of any robots associated therewith.

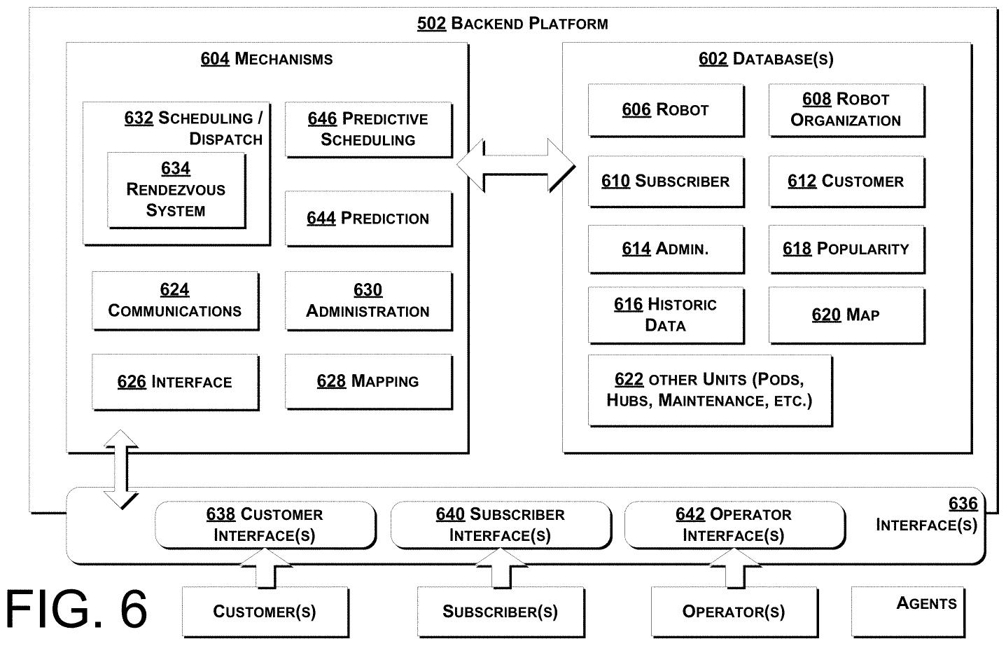

Aspects of an exemplary backend platform 502 of a delivery framework 500 are described now in greater detail, with reference to the drawing in FIG. 6.

The backend platform 502 preferably includes one or more databases 602, and one or more mechanisms 604 to carry out and/or support its functionality.

Although shown as separate databases in the drawing, those of skill in the art will realize and understand, upon reading this description, that the various databases may be combined in a single database or organized differently. Further, the various databases may be distributed in various locations. Similarly, although multiple mechanisms are shown, the functionality of some or all of the mechanisms may be combined or organized differently. The scope of the inventions described herein is not limited by the organization or location or implementation of the databases or the mechanisms.

The databases 602 may include robot database(s) 606, robot organization database(s) 608, subscriber database(s) 610, customer database(s) 612, administrative database(s) 614, historical data database(s) 616, popularity database(s) 618, map database(s) 620, other unit database(s) 622.

As used herein, a subscriber or partner refers to an entity or person that uses the delivery framework to deliver goods and/or services. A subscriber may be, e.g., a store, a restaurant, a shipping company, a delivery company, an individual, or a company. The system is not limited by the nature of the subscriber or partner.

As used herein, a customer is an entity or person that uses the delivery framework to receive goods and/or services. The system is not limited by the nature of the customer.

The mechanisms 604 may include communications mechanisms 624, interface mechanism(s) 626, mapping mechanism(s) 628, administration mechanism(s) 630, scheduling and dispatch mechanism(s) 632, prediction mechanism(s) 644, and predictive scheduling mechanism(s) 646. The scheduling and dispatch mechanism(s) 632 may include a rendezvous system 634. The various mechanisms 604 may connect and interact with the databases 602 as needed.

The backend platform 502 preferably includes one or more interfaces 636, including customer interface(s) 638, subscriber interface(s) 640, and operator interface(s) 642.

The various interfaces 630 support interface with the various mechanisms 604, possibly via interface mechanism(s) 626. In this manner, various entities (e.g., customers, subscribers, and operators) can interface with the backend platform 502, as appropriate. As should be appreciated, suitable restrictions and security are preferably applied to the various entities and classes of entities.

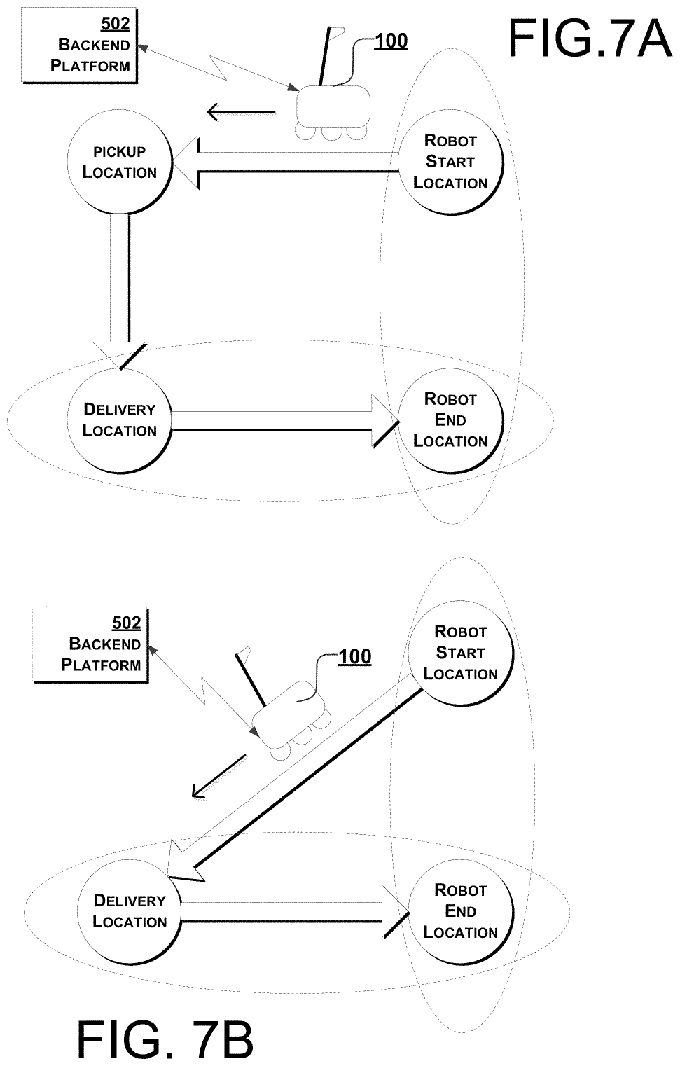

Prior to describing the framework further, various aspects of robot delivery are discussed. With reference to FIGS. 7A and 7B, a robot 100 making a delivery (of goods and/or services) has start location, a pickup location (assuming that the robot has to pick up goods or has to somehow be configured for the delivery), a delivery location, and an end location. The delivery location may be the same as the end location. The start location may be the same as the end location. The start location may be the same as the pickup location; and the end location may be the same as the pickup location. In the case where the robot 100 is pre-stocked with goods (e.g., food or candy or a coffee maker), the start, delivery, and end locations may be the same. For example, a robot configured with a coffee maker and food may stay substantially in one location and vend (deliver) goods to multiple customers at that location. The start, pickup, and/or end locations may be arbitrary locations and may include pods, hubs, maintenance units, and robot-carrying vehicles (motherships). Persons skilled in the art will realize, upon reading this description, that pickup locations are optional, and may not be part of the delivery process. That is, a robot may start at a start location, travel to a delivery location and then travel on to an end location. Additionally, or alternatively, a robot may start at a start location, travel to a pickup location, be picked up there by a robot-carrying vehicle, be transported to (or near) a delivery location, and then travel on to end location (possibly via one or more other pickup locations).

Within a particular geographic region, the system may set or designate certain locations as preferred start or end locations. These preferred locations may, for example, be locations of pods, hubs, or maintenance units (e.g., battery changing units), or drop-off/pickup locations of robot-carrying vehicles.

As should be appreciated, while the start, pickup, and delivery locations may have to be fairly precise (e.g., a street address or the like), the end location may sometimes be less precise (e.g., a region at or near a particular street address).

The backend platform 502 preferably maintains information in robot database(s) 606 about all robots in the system 500.

All robots that use or are part of the delivery framework/system 500 are preferably registered with the system. As noted above, each robot has a unique identifier 414 (e.g., a serial number or the like that is unique within the framework 500), and this unique identifier may be used to uniquely identify each robot in the system. Each robot's unique identifier may be used as a key or primary index to the robots database(s) 606.

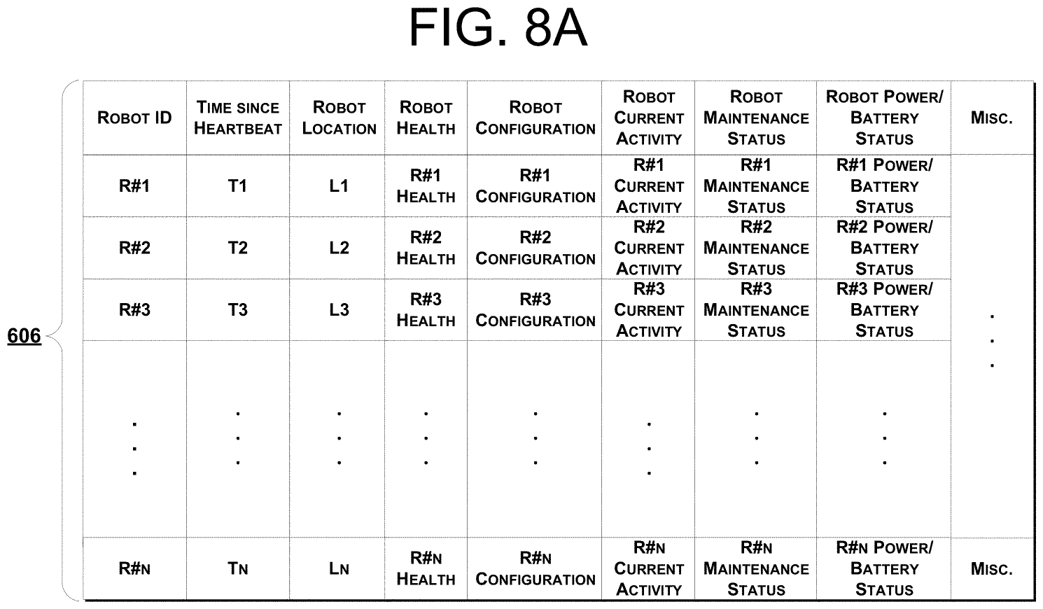

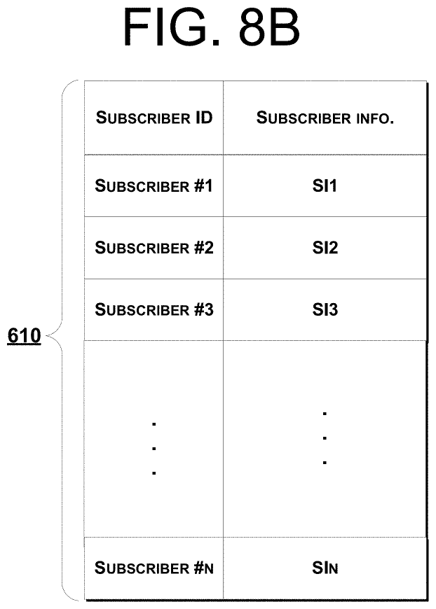

FIG. 8A depicts aspects of an example robots database(s) 606. As shown in the example in FIG. 8A, the robots database may include a record for each robot in the system, keyed, e.g., on the robot's unique identity. The system may thus determine the current status of each robot in the system. Note that each robot's database record may include data corresponding to the robot's status data (350, FIGS. 3 and 4). This status may be updated routinely by the robots. The backend platform 502 may maintain heartbeat information for each robot, which may be used to determine if a robot has gone offline. In which case, robot can also send some signal and nearby human can connect to the backend platform 502. The backend platform 502 may determine information about each robot using the data in the robot database. The information may, e.g., be derived from those data, alone or in combination with other data. For example, using information in the robot database 606, backend mechanism(s) 604 (e.g., the scheduling/dispatch mechanism(s) 632) may determine the current capacity of a robot and thus its ability to make a particular delivery or provide a particular service. The robots database(s) 606 may include other information (not shown), including cryptographic certificates and the like to support secure and private communication between the backend platform and the robots.

Preferably, the robots database(s) 606 is maintained and updated in real time to reflect the current status of the robots in the system. The robots database(s) 606 thus preferably provides a true or substantially true state of the robots in the system.

Each subscriber preferably has a unique subscriber identifier (ID). The subscriber database(s) 610 includes information about each subscriber, preferably keyed on the subscriber ID (see, e.g., FIG. 8B).

The backend platform 502 may make and maintain data about robot activity and about deliveries that have been requested and/or made. Such data may be in historic data database(s) 616. For example, for each particular delivery or service request (whether or not delivery or service was successful), the historic data database(s) 616 may maintain and store information about the time of the request, the robot start location, the intended delivery destination, a pickup location (if needed), the type of goods being delivered or picked up (if any), the requested service (if any), the subscriber associated with the delivery or service, the customer, the route taken for the delivery, the robot end location, and other information. If necessary, the historic data may be anonymized to remove customer identification.

Preferably, the historic data database(s) 616 is maintained and updated in real time to reflect current requests for goods and services.

The backend platform 502 may make and maintain data about which goods and services have been or are currently being requested. Such data may be stored and maintained in the popularity database(s) 618 and preferably includes the goods/services by time and location. If necessary, the popularity data may be anonymized to remove customer identification. For example, the location may be an exact address or an area or region. The goods or services may be categorized or typed.

Preferably, the popularity database(s) 618 is maintained and updated in real time to reflect current requests for goods and services.

The popularity database(s) 618 may also include data derived or determined from historic data database(s) 616. For example, the prediction mechanism(s) 644 may use historic data in historic data database(s) 616 to predict popularity of certain goods or services at certain times and/or locations. The predictive scheduling mechanism(s) 646 may use historic data in historic data database(s) 616 to pre-schedule robots in certain locations and/or with certain configurations, and/or with certain goods. In this manner, robots may be pre-positioned and configured in anticipation of having to carry out certain types of deliveries or provide certain types of services. For example, if the prediction mechanism(s) 644 find that historic delivery data in historic data database(s) 616 shows demand for pizza deliveries every Thursday night at 11 PM in a particular location (e.g., a university dormitory), then the predictive scheduling mechanism(s) 646 may pre-position a fleet of appropriately configured robots at a suitable location (e.g., a pizza shop) to handle that demand. The robots may be pre-positioned in any manner. For example, one or more robot-carrying vehicle may be used to move at least some of the robots to the suitable location. The robots may be charged, calibrated, and/or configured while being moved. In addition, or instead, the end location for robot deliveries may be set to the desired location so that at least some robots end their deliveries at that location and are ready to deal with the expected demand.

As should be appreciated, over time, demand may vary or dissipate. However, if the prediction mechanism(s) 644 finds ongoing demand of a certain type (e.g., configuration, time of delivery, etc.), then that information may be used to pre-position other components (e.g., battery chargers, etc.).

As described below, distinct delivery frameworks may share load with each other. For example, as described below, one framework may request delivery help from other frameworks. Information about requests from other frameworks may be used to augment data in historic data database(s) 616 and popularity database(s) 618. The prediction mechanism(s) 644 may thus use information about requests from other frameworks to make predictions.

The backend platform 502 may make and maintain map data 620, using the mapping mechanism(s) 628. Map and navigation data may be provided to robots from backend platform. Robots may store this map and navigation data, e.g., as map data 344 (in data 342), for use, e.g., by the navigation mechanism(s) 330 and mapping mechanism(s) 332. While the backend platform 502 may maintain map data 620 for the entire system, a particular robot may only have map and navigation data for a specific region.

Robot Selection

As discussed above, with reference to FIGS. 7A and 7B, a delivery by a particular robot includes a start location, optional pickup location, delivery location, and end location. While FIGS. 7A and 7B showed a single robot, a delivery framework has multiple robots, and more than one of the robots may be able to make a particular delivery. It can be appreciated that because of the wheels 104 of the robot 100 it can be used in areas with inclination, which is not only restricted to slopes or tilted surfaces but also rocky and/or cobble stone streets. It may also be noted that the robot 100 can move in any direction and make difficult turns by varying the direction and speed of each wheel.

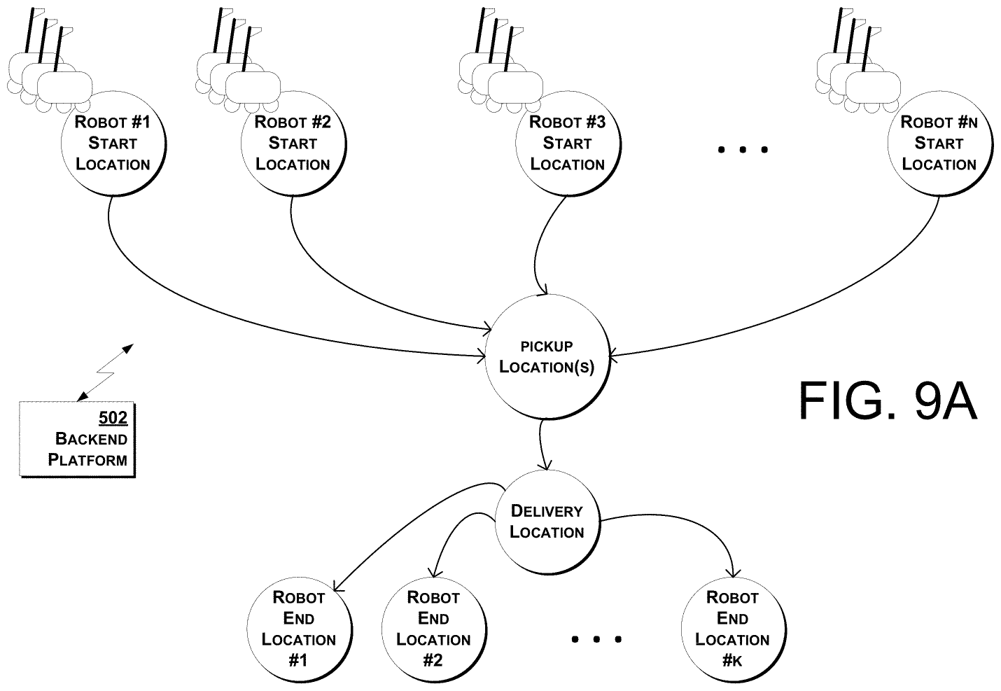

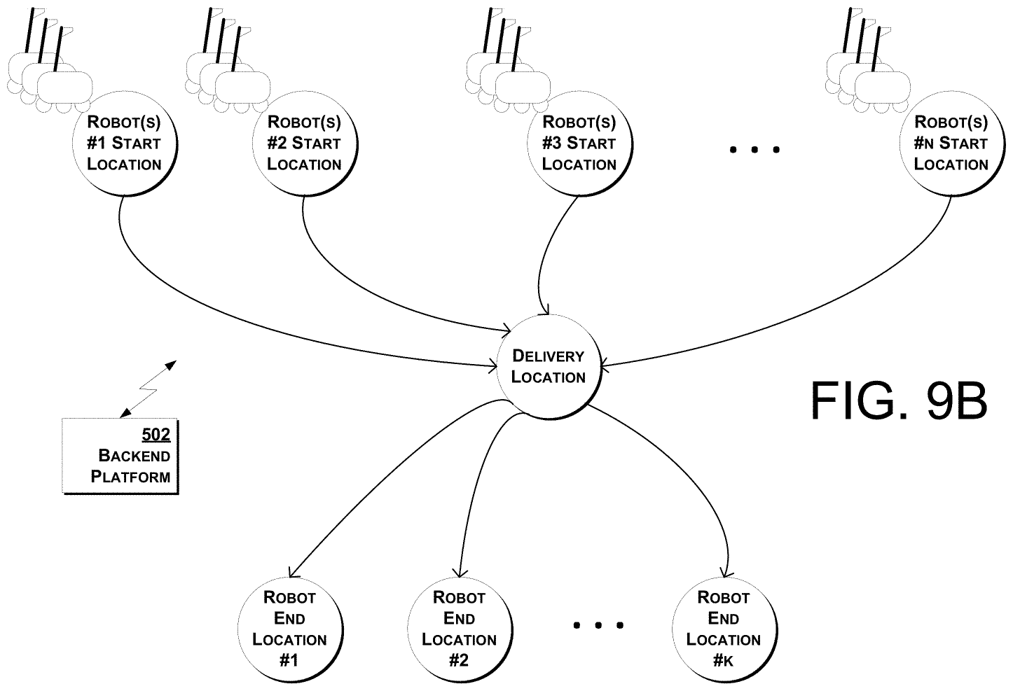

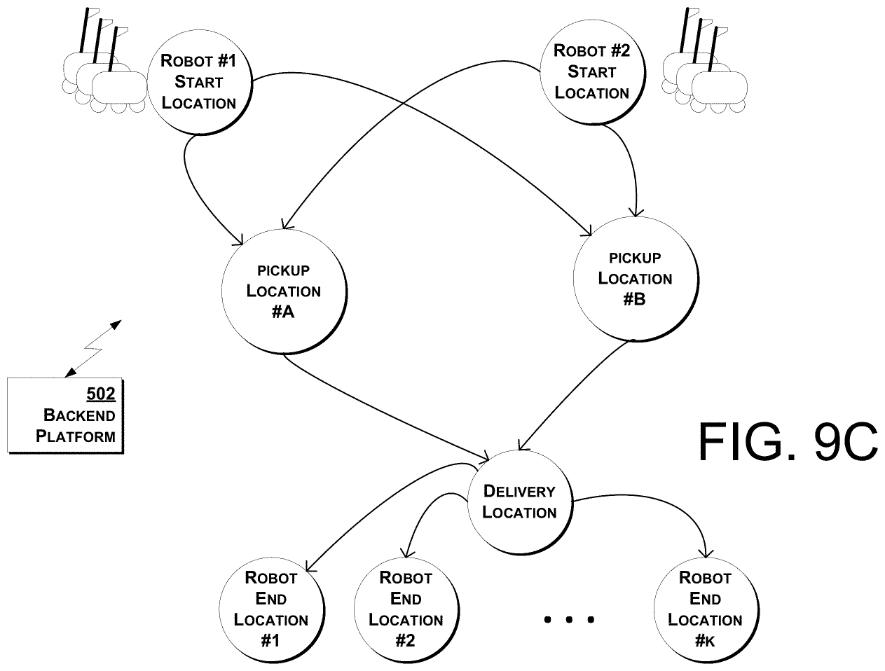

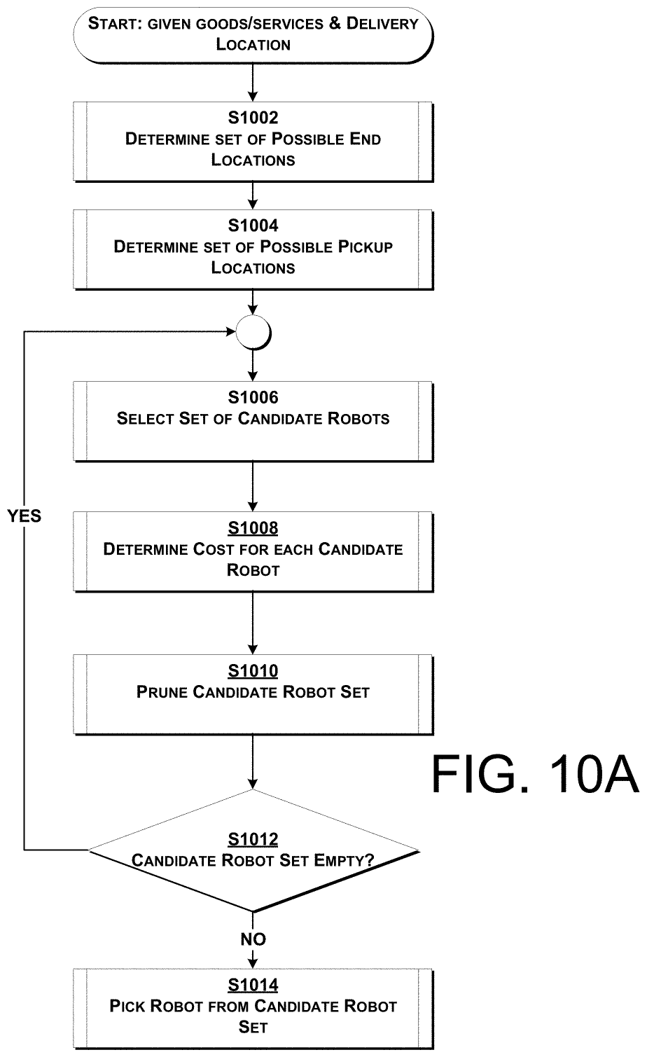

As shown in FIGS. 9A and 9B, a delivery framework may include one or more robots at each of one or more start locations. In the drawing n start locations are shown, where n≥1, each having one or more robots. FIG. 9A corresponds to the scenario shown in FIG. 7A, where the delivery requires an intermediate stop at a pickup location. FIG. 9B corresponds to the scenario shown in FIG. 7B, where no pickup is required (e.g., because the robot already has the goods or services).

As shown in FIG. 9A, there may be multiple possible pickup locations for a particular delivery. For example, if the goods or services are fungible (e.g., a can of soda or a bottle of beer), there may be more than one pickup location at which a robot can obtain the needed goods. This situation is explained further in the example in FIG. 9C, where one or more robots at two start locations (#1, #2) can each make a delivery via one of multiple pickup locations (#A, #B). Note that even if a shorter path exists via one particular pickup location, another pickup location may be preferable if the other pickup location has more goods. Thus, e.g., it may be preferable to leave some goods of each kind at each pickup location.

Each start location in FIG. 9A may be an arbitrary location, including a pod, hub, a maintenance unit such as a battery changing unit, and robot-carrying/moving vehicle. For a skilled person in the art it will be obvious that the robot can be equipped with a navigator to find its nearest location, in case it needs some repair during the journey.

With reference again to FIG. 6, for a particular delivery (with a known desired delivery location and known goods/services), the rendezvous system 634 in scheduling/dispatch mechanism 632 (in the backend platform 502) selects, possibly from multiple robots at possibly multiple locations (see FIGS. 9A-9B) an appropriate robot to make the delivery. As used herein, the term “rendezvous” refers to the process or act of associating a particular robot with a particular delivery.

As used herein, an “appropriate robot” for a delivery is a robot that can successfully complete a delivery (i.e., deliver the goods/services from the start location to the desired delivery location and then get to the desired end location). As should be appreciated, to successfully complete a delivery, the robot must have at least:
(1) sufficient power (battery) capacity;
(2) the required configuration (e.g., an appropriate storage unit (e.g., heated, refrigerated, etc.), sufficient consumables (e.g., coffee, water, milk, cups, etc.)
(3) the kind of wheels/legs on the robot depending on the geography of the area.

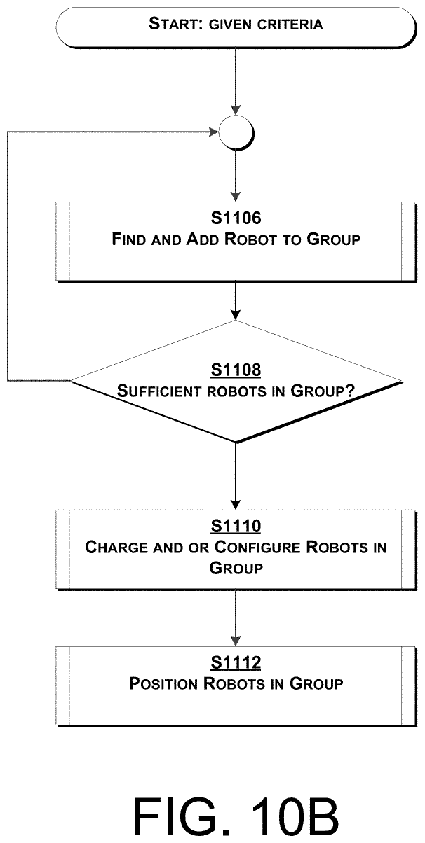

Exemplary operation of the rendezvous system 634 is shown in the flowchart in FIG. 10A, which shows selection of an appropriate robot to make a particular delivery (i.e., a delivery of particular goods to a particular location). For the sake of this discussion it is assumed that the delivery is to be made at the time of the calculation.

Given as input particular goods and a particular location, the rendezvous mechanism 634 first selects (at S1002) a set of possible end locations. The set of end locations comprises one or more locations at which the delivery can end (see, e.g., FIGS. 7A, 7B, and 9A-9C). The end location(s) may include the delivery location and the start location (if appropriate) and may be selected, e.g., based on distance from the delivery location. The set of possible end locations (determined at S1002), may vary, e.g., by time of day. For example, after a certain time (e.g., 6 PM), it may be desirable to have robots end their deliveries at hubs or maintenance stations or at pickup locations for robot-carrying vehicles. In some cases, the set of possible end locations (determined at S1002), may vary based on current or expected demand on the system. For example, using historic data 616 in the database(s) 602 of the backend platform 502, the system may determine that it is preferable to move robots to a particular geographic region or regions. The possible end locations may thus be selected to favor end locations in those particular geographic region or regions. In this manner, robots may effectively migrate over time to certain regions.

If the delivery requires a pickup, the rendezvous mechanism 634 then determines (at S1004) a set of possible pickup locations. If there is only one possible pickup location (e.g., if the goods are not fungible), then the set of possible pickup locations will contain only the one pickup location. If there no pickup is required, then the set of possible pickup locations will be empty.

Next, the rendezvous mechanism 634 selects (at S1006) a set of robot candidates for the delivery. The initial set of robot candidates may be determined using information in the robot database(s) 606. For example, in some embodiments, the rendezvous mechanism 634 may select a subset of robots in the robot database(s) 606 that are: (a) healthy, (b) already appropriately configured for the delivery; (c) currently available; and (d) at a location within some given radius of the delivery location. Those of ordinary skill in the art will appreciate and understand, upon reading this description, that different and/or other criteria may be used to determine an initial candidate set.

Having determined an initial set of candidate robots (in S1006), the rendezvous mechanism 634 then determines (at S1008) a delivery cost for each robot in the set of candidate robots. The cost for a delivery by a particular robot in the candidate set may be based, e.g., on (i) a then-current route from the particular robot's start location, via a pickup location, to the delivery location; and (ii) the robot's current power/battery status. Thus, in some aspects the cost is a measure of a robot's current ability to complete the delivery and then get to a suitable end location. The cost may also be a function of the expected travel time of the delivery. In the case of a delivery requiring a pickup, the pickup time may be set to zero or some constant time, so that the cost is only a function of travel time.

A particular robot may have multiple costs if there are multiple pickup locations (i.e., if the set of possible pickup locations has more than one location). In that case, the cost for a particular robot may be the minimum cost of that robot over the various pickup locations.

If a particular candidate robot cannot make the delivery and reach an end location in the set of possible end locations, then the cost for that robot may be set to infinity (guaranteeing that it is not selected).

Having determined a cost for each candidate robot (at S1008), the rendezvous mechanism 634 may then prune the candidate robot set (at S1010) to remove those candidates that could not complete the delivery (e.g., to remove candidate robots with a cost of infinity).

If, after the pruning (at S1010), the candidate robot set is not empty (at S1012), then the rendezvous mechanism 634 may pick a robot from the candidate robot set (at S1014). The selected robot may, e.g., be a robot with the lowest cost.

If multiple robots have the same cost, the rendezvous mechanism 634 may randomly select one or may use other factors (e.g., remaining battery power) to pick a robot.

In other embodiments, the cost function may be weighted to favor (or disfavor) robots at a particular start location. The weighting may be dynamic and may be based, e.g., on the number of robots currently at that start location. The weighting may also be based on future expected demand for robots at a particular start location.

For example, with reference again to FIG. 9, the system may try to have a certain minimum number of robots at a particular start location during a particular time period. In these cases, the cost for robots at that location may be weighted higher. It can be understood that the cost is a function of delivery time but is not only dependent on it. It can also vary with the size of the package, weather in the region (for example, the battery will lose energy faster in cold regions as compared to the warm ones) and/or the number density of the delivery locations in a particular region.

If, after the pruning (at S1010), the candidate robot set is empty (at S1012), then the rendezvous mechanism may select another set of candidate robots (at S1006) and repeat the process. The second set of candidate robots may be selected with less strict criteria than were used for the first set of candidate robots. For example, the distance to the delivery location may be increased, or a robot may be selected that is not already appropriately configured. The process (S1008, S1010, S1012) is then repeated for the second set of candidate robots.

The process may be repeated a predetermined number of times, each time relaxing the candidate criteria, until an appropriate robot is found.

Once an appropriate robot is found, the robot is dispatched for delivery (by scheduling/dispatch mechanism 632). The rendezvous mechanism may mark the selected robot as selected in the robot database, to prevent it from being selected again. However, once selected, the robot should modify its own status data 350 (FIG. 4) to reflect that it is on a delivery. This change should then automatically propagate to the robot database 606 on the backend platform.

As should be appreciated, the process described above with reference to the flow chart in FIG. 10A is merely exemplary, and different and/or other mechanisms may be used to select an appropriate robot for a particular delivery.

The process described above with respect to the flowchart in FIG. 10A may be modified to include, as an input, a maximum delivery time. This may be acceptable, e.g., when the delivery is for a package that can be delivered at any time within a certain window or by a certain deadline. In those cases, the pruning (in S1010) should remove any robot that cannot meet the deadline, and the robot selection (in S1014) need not pick the robot with the lowest cost (as all robots that remain in the candidate set at that point can satisfy the delivery window).

In some cases, the robot selection (in S1014) may be based, e.g., on a policy of getting robots recharged or reconfigured. In such cases, the robot selection (in S1014) may choose a robot from the candidate robot set with the least amount of battery power (albeit sufficient for the current delivery), where the end location is a battery replacement station or a pickup location for a robot-carrying vehicle.

Robot Networks and Groups

As noted above, a particular delivery framework 500 includes multiple robots, sometimes referred to as a fleet of robots. These robots may be logically organized into groups or sets or networks of robots. For example, robots may be logically organized into groups or networks of robots based on one or more factors, such: their current location, their current capacity, and/or their configuration (e.g., whether they are currently configured with a particular specialized storage unit or with a particular preparation mechanism), desired location, maintenance status, etc. In some cases, robots may be branded for a particular type of goods or for a particular provider, and such branding may be used to group robots.

The logical organization of robots may be maintained by the backend platform 502 using, e.g., mechanisms 604 and the database(s) 602. In particular, mechanism 604 may use the robot database(s) 606 and the robot organization database(s) 608 to maintain information about the logical grouping of robots.

Networks may, but need not, be homogenous. For example, in one type of mechanism there can be robots with different capacities and/or shapes.

A particular robot may be in more than one group or network. Robots can be grouped by using their unique IDs. For example, robot belonging to a same group can have same first three characters in their IDs.

As should be appreciated, a group or network is a logical organization of a subset of the robots in a fleet. A group may, at times, have zero members, and a group may include the entire fleet.

Robot groups or networks may be dynamic. Thus, a network or group may have robots added or removed. For example, membership of a robot group or network may be modified based on historic data 616 stored in the database(s) 602. Membership of a robot group or network may also (or instead) be modified based on real-time feedback and/or demand. Thus, e.g., a robot group may be created or modified to deal with an expected demand in a particular location and at a particular time. Expected demand may be based, e.g., on previous demand at that location and time. For example, as described above, if the prediction mechanism(s) 644 find that historic delivery data in historic data database(s) 616 shows demand for pizza deliveries every Thursday night at 11 PM in a particular location (e.g., a university dormitory or campus), then the predictive scheduling mechanism(s) 646 may form a group of appropriately configured robots to handle that demand. The size of the group can be kept low (or even at zero) at other times, and can be expanded in sufficient time before the expected demand. Once the demand period has passed, the group may be fully or partially disbanded.

Networks or groups may be used, e.g., to aid in the selection of an appropriate robot to make a delivery. For example, the selection of a set of candidate robots (S1006 in FIG. 10A) may initially use a set of robots having a particular configuration (e.g., vending or coffee making or the like).

Subscriber Commitment

In some embodiments, different subscribers may be given or require different quality of service (QoS) or time commitments. These commitments may be provided, e.g., based on fees or the like.

In such embodiments, a subscriber may be allocated a group or network of robots that is expected to satisfy their QoS requirements. In such embodiments, with reference again to FIG. 10A, the set of candidate robots (in S1006) is made from the subscriber's group of robots.

The size of a particular subscriber's robot group may be modified based on current or expected load and/or capacity demands, where expected load and/or capacity demands may be determined using historic data database(s) 616 in the backend platform 502.

Prepositioning, Pre-Configuring, and Migration

As noted above, historical data (e.g., historic data 616 in the database(s) 602) and/or popularity data (e.g., in the popularity database(s) 618), may be used to determine or predict potential demand for certain kinds of deliveries and/or services by location, time, day, etc.

Exemplary group formation and maintenance is described with reference to the flowchart in FIG. 10B. Given a set of criteria (e.g., size, capacity, configuration, location, etc.), find and add (at S1106) a robot satisfying the given criteria to the group. If the group has sufficient robots (as determined at S1108), then the group formation is done, otherwise the process tries to find and add another robot to the group.

Preferably the finding (at S1106) finds robots that meet all criteria, including capacity and configuration. However, since that may not be the case (e.g., there may not be enough appropriately configured robots), at least some robots in the group may need to be appropriately configured (or reconfigured) and some robots may need to have their capacity increased (e.g., their batteries charged or replaced). Accordingly, (at S1110), robots in the group needing charge or configuration may be charged and configured.

There is no geographic requirement, per se, on group membership. However, one of the criteria for group membership may be for robots at or near a particular location.

Having formed a group of robots, it may be desirable to position the group at or near a particular location (e.g., in anticipation of demand or to meet current demand). Accordingly, (at S1112), robots in the group may be moved or migrated to the particular location. Robots in the group that need to be moved may be moved en masse, e.g., using a robot-moving vehicle, and/or migrated to the location.

Robot groups are dynamic and may change based, e.g., on real-time feedback, popularity information, and historic data. The backend platform 502 therefore preferably monitors groups and adjusts their membership as needed (and if possible). For example, the backend platform may disband (or, effectively, empty) a group that is no longer needed (e.g., a group that was formed to meet a particular demand at a particular time and place). Similarly, the backend platform may increase (or decrease) the size of a group based on increased (or decreased) demand. And the robots can be modified and use for other mechanisms in other groups.

When forming a group, preferably the backend platform 502 finds robots (at S1106) that match as many of the criteria as possible (e.g., configuration, capacity, location, etc.).

Migration and Location

It may be desirable to have one or more robots positioned at or near a particular location (e.g., to meet future or current demand, to be picked up for maintenance, etc.). While robots may be collected and delivered to a particular location, robots may also be migrated (over time) to a location. It is also to be noted here that because of the size and the adaptable transportation mechanism (such as wheels, legs, tracks), robot(s) can be easily transferred in and/or out of vehicles.

Recall, as shown in FIGS. 9A-9B, a delivery may have multiple possible end locations. Robots may be migrated by setting the possible end locations to be at or near the desired migration location. In this manner, as deliveries occur, robots may gradually approach the desired migration location (or a suitable pickup location from which they can be taken to the desired migration location).

Robots may be migrated based on group membership. For example, if it is desired to get a group of robots to a particular desired location, the delivery end locations for robots in that group can be set to be at or near (or reachable from) the desired location. In that manner, over time, robots in the group will migrate to the desired location.

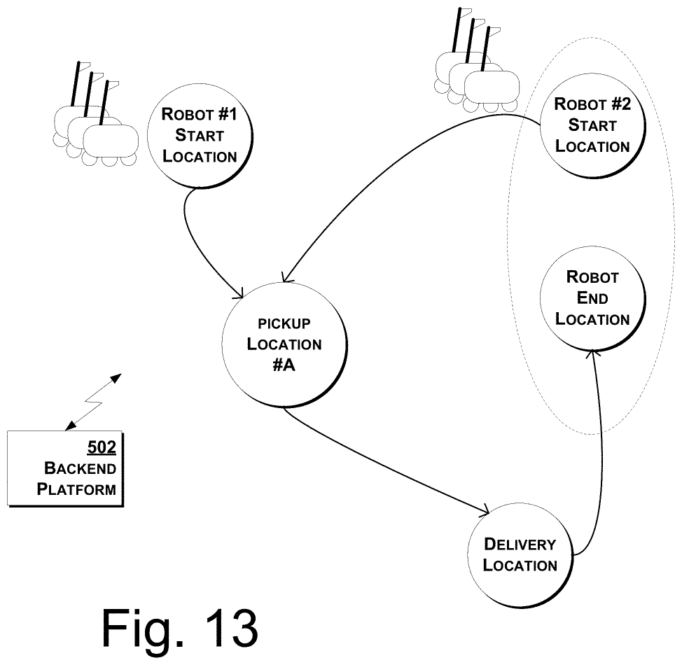

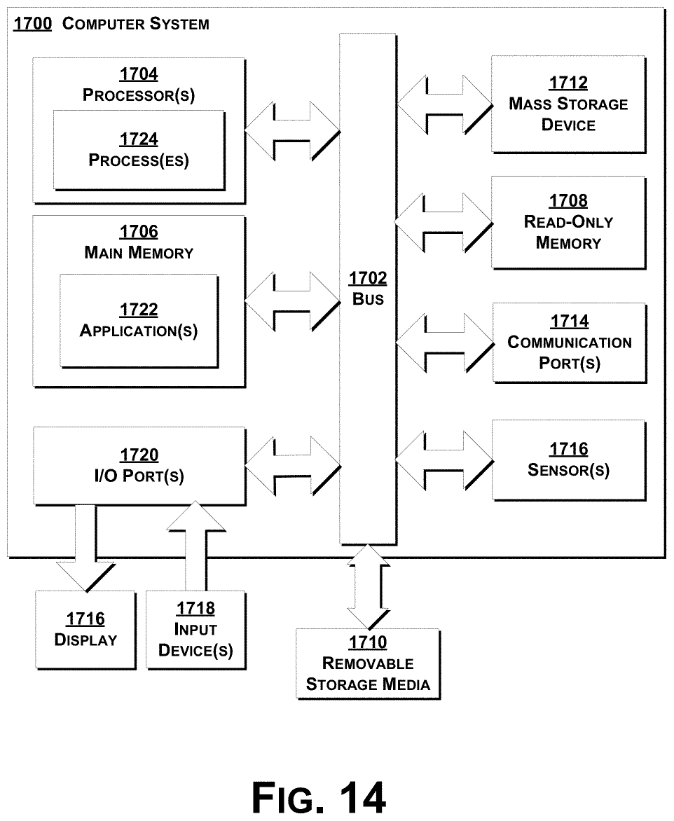

Consider the example shown in FIG. 13A, in which one or more robots are already at the robot end location. The robot selection mechanism should select, for this particular delivery, a robot that is not already at the desired robot end location. As can be seen, in this manner, robots not already at the desired end location may be migrated to that location. With reference again to FIG. 10A, the cost for robots already at the desired end location can be set higher (at S1008) to discourage their selection. Alternately (or as well), the selection (at S1014) may favor robots that have to be migrated. It can also be done by checking the time and location of the last delivery and if there is any delivery left in that particular region and/or on the way to its end location, the robot can take it even if it was assigned to another robot and can update the information in the system of that robot. This optimization of the delivery (s) can be decided by the backend platform 502 using the status data of all the robots in a group working in a region.

Geographical Fencing

It may be desirable (or necessary) to restrict robots to particular locations or regions. This may be useful (or necessary) for administrative or regulatory or legislative reasons. Geographic fencing (also called geofencing) may be used to control the location of robots. Geofencing may be positive (or permissive) and/or negative (or restrictive). For example, a fleet or group of robots may be branded in a certain manner (e.g., for a particular vendor or subscriber), and those robots may need to be located within that subscriber's territory. In that case, the robots are permitted anywhere within a certain region and restricted outside that region. As another example, the robots in a particular city may not be allowed close to certain building or areas.

Geofencing may be used to implement or encourage robot migration. For example, all robots outside a particular region may be required to make their way into that region, regardless of whether or not they are making a delivery.

Robot Fleets

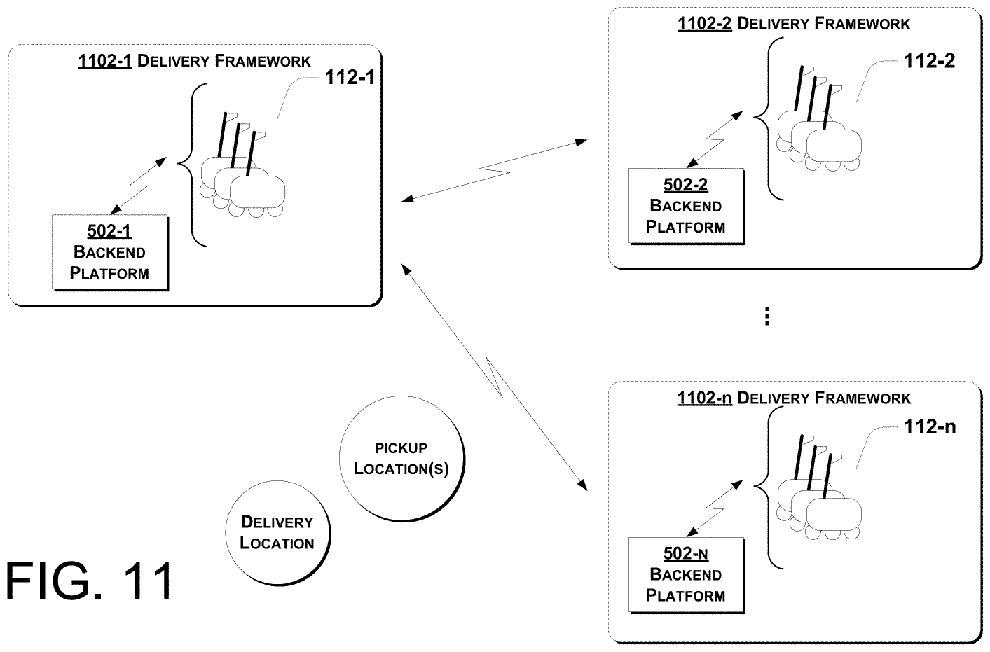

While the system has been described with respect to a single framework with a single backend platform 502 (e.g., as shown in FIG. 5) and having a single fleet of robots, it should be appreciated that there may be multiple frameworks, each operating their own fleet of robots. For example, as shown in FIG. 11, in a first delivery framework 1102-1, backend platform 512-1 operates a fleet 112-1 of robots, in a second delivery framework 1102-2, backend platform 512-2 operates a fleet 112-2 of robots, . . . and in an n-th delivery framework 1102-n, backend platform 512-n operates a fleet 112-n of robots.

The various backend platforms of these delivery frameworks may include some or all of the functionality described above.

Each framework may, but need not, also include components such as pods, hubs, maintenance units, robot carrying vehicles, and the like.

The robots in each particular fleet may be as described above, although some fleets may be homogenous, having only one kind of robot configured in a particular way. For example, a fleet may only have robots with heated compartments.

The frameworks/fleets may be owned and operated by the same entities or by different entities.

In operation, in some exemplary embodiments hereof, a particular backend platform (e.g., 502-1) may engage robot(s) of one or more other robot fleets (i.e., one or more other frameworks) to perform one or more particular deliveries or services. For example, the delivery framework 1102-1 may engage one or more robots of one or more of the other delivery frameworks (1102-2 . . . 1102-n). In effect, a delivery framework may act as a customer of another delivery framework.

Consider a scenario in which a particular delivery framework needs to schedule a particular delivery. Information about the delivery includes: (i) a pickup destination (PU), (ii) a delivery destination (DD), (iii) a pickup or delivery type (e.g., the type of goods or services) (PT), and (iv) time constraints for the delivery (TC). The time constraints may specify, e.g., a time period during which delivery must be made or during which delivery is acceptable. The delivery may comprise a pickup from the delivery location and then subsequent delivery to an end location (EL). In that case, the information about the delivery may include information about the end location. It may be noted here that the EL may/may not be the same as the last delivery location.

In one example, as described above with reference to FIG. 10A, the process of robot selection by a particular delivery framework may require iterating over a candidate set of robots, relaxing the candidate criteria, until an appropriate robot is found.

In such cases, e.g., the particular delivery framework may determine if another delivery framework can handle the delivery request.

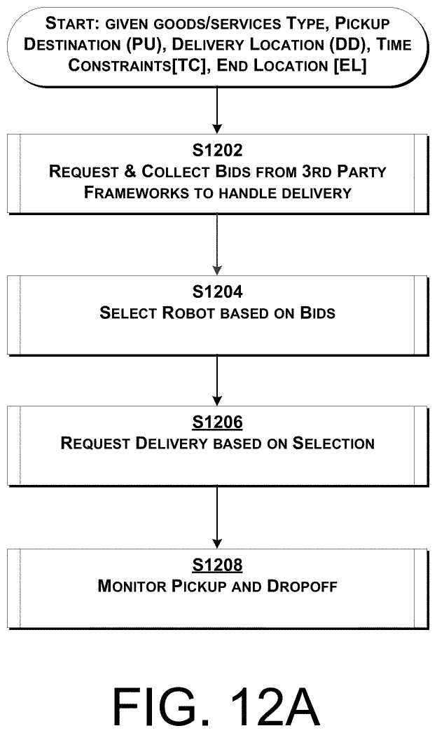

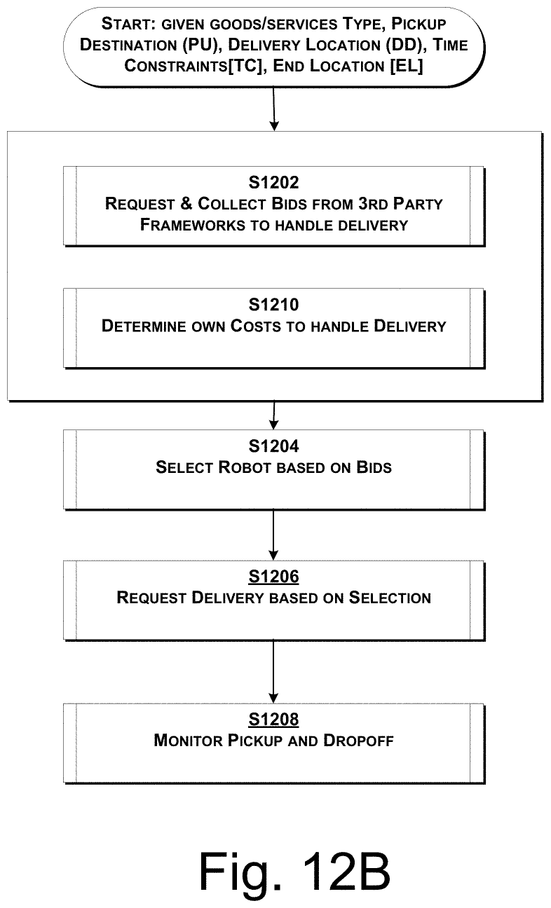

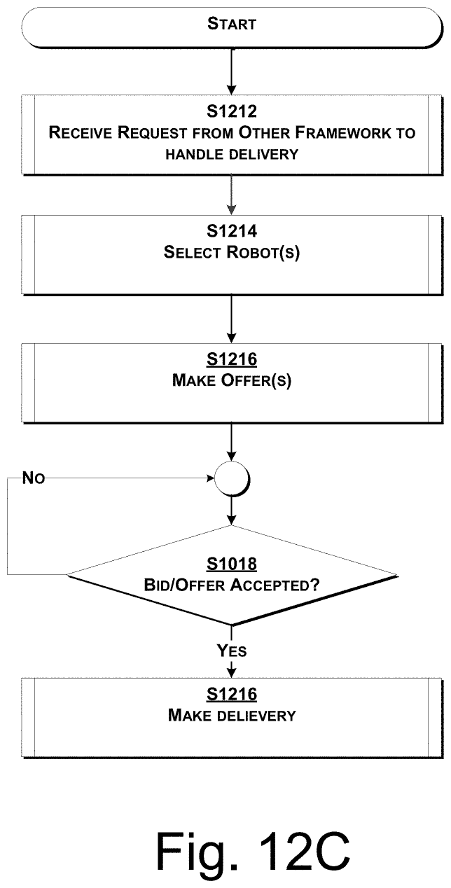

With reference now to the flowchart in FIG. 12, the particular delivery framework (the framework that is trying to schedule a particular delivery) requests and collects bids (at S1202) from other (third party) frameworks for this particular delivery. Preferably each other framework determines whether or not it can handle the particular delivery based on the parameters provided about the requested delivery (e.g., pickup destination (PU), delivery destination (DD), pickup or delivery type, optional end location (EL), and time constraints for the delivery (TC), as described above). Preferably a framework will not intentionally offer to handle a delivery that it knows it cannot handle.

Each other delivery framework receiving a request can chose whether or not to respond to a request. Each other delivery framework receiving a request can make its own determination of whether or not it can handle the request (e.g., using the rendezvous mechanism described above with reference to FIG. 10A).

A bid from another framework for a particular request preferably comprises an offer from the other framework to handle the particular request. The offer may be for one or more robots of the other framework that can handle the request. The bid may include a cost and may include information about the robot(s) that the other framework is offering for the request (e.g., the current location(s) of any robot(s) that the other framework is offering). In some cases, the bids may also include information about expected service times (e.g., anticipated pickup time, anticipated delivery time, etc.). A bid may include an expiration time or it may have a default time to live (TTL).

Since there may be multiple other frameworks, a request for bids may result in multiple bids, each with a corresponding set of one or more robots and associated information.

The requesting framework may stop collecting bids after a certain time (e.g., 30 seconds or 1 minute).

Once the bids are collected (at S1202), the requesting framework may (at S1204) select a robot based on the bids. The selection may be based on one or more factors, including, e.g., cost, expected service times, relationship with other delivery framework, etc.

Having selected a robot to make the delivery, the requesting framework (at S1206) requests the delivery from the other delivery framework, based on the bid. Preferably the other framework acknowledged the request and provides the requesting framework with information about the delivery (e.g., tracking information).

The requesting framework then (at S1208), monitors the pickup (if needed) and delivery.

Note that the requesting framework need not provide the other delivery frameworks with a desired end location for their delivery robots. However, in some cases the requesting framework may provide (e.g., as a suggestion) a list of one or more end locations or an end region. This may be done if the requesting framework anticipates (e.g., based on historical data) the need for more delivery robots in a particular region. The other delivery frameworks are free to ignore end location information provided with a delivery request.

In the above scenarios, the requesting delivery framework had already determined its own ability to handle (or not handle) the request. In alternate embodiments, the requesting framework may make requests of other frameworks before or while making its own evaluation. For example, as shown in FIG. 12B, while waiting for responses from other delivery frameworks (or before requesting them) the particular delivery framework may (at S1210) determine its own options for handling this particular delivery. Effectively, the particular delivery framework tries to find a set of candidates from its own robots to handle the request (e.g., as described above with reference to FIG. 10A).

The request and collection of bids (at S1202) may proceed in parallel with the particular framework's own deliberations (at S1210).

The selection of robots (at S1204) may then select from all bids (i.e., from bids from other delivery frameworks) and from robot candidates of the requesting framework (determined at S1210). The selection of a particular robot to handle a request may be based on factors listed above (e.g., cost, expected service times, relationship with other delivery framework, etc.).

As should be appreciated, if the requesting delivery framework uses one of its own robots (selected at S1204), then it does not need to make the request (at S1206) of any other framework.

In both scenarios, a requesting framework may notify other frameworks of unaccepted bids, thereby allowing them to release those robots before expiration of their respective bids.

Relationships with Other Delivery Frameworks

Delivery frameworks may establish relationships with other delivery frameworks. For example, delivery frameworks may handle reciprocal delivery agreements with other delivery frameworks. These arrangements may take any form and may include pricing, minimum delivery requests, etc. In some cases, delivery frameworks may have preferential delivery arrangements in certain geographical regions, and may thus provide better service in those regions.

The arrangements between delivery frameworks may influence the robot selection described above (at S1204). For example, bids with apparent identical costs may differ based on prior arrangements between the delivery frameworks.

When a delivery framework uses a robot of another framework, payment for that use may be made in any known manner and may depend on prior agreements/arrangements between the framework operators.

Making a Bid

The flowcharts in FIGS. 12A-12B show aspects of operation of a framework requesting (and possibly obtaining) offers to handle a particular delivery. Exemplary operation of framework receiving such a request (to handle a particular delivery) is described now, with reference now to the flowchart in FIG. 12C.

First (at S1212), the framework (the backend platform) receives a request from another framework to possibly handle a delivery. Recall that a request from another framework to handle a particular delivery (e.g., S1210 in FIGS. 12A-12B) includes information about the delivery (e.g., optional pickup destination (PU), delivery destination (DD), pickup or delivery type, optional end location (EL), and time constraints for the delivery (TC)).

The framework's backend platform then (at S1214) determines possible candidate robots to handle the request (using, e.g., the process described above with reference to FIG. 10A). Note that the process described at S1014 (in FIG. 10A) preferably selects a single robot. However, the process may choose more than one candidate in response to a request from another framework.

If the selection (at S1214) is non-empty (i.e., if one or more robots are found that could handle the requested delivery), then (at S1216) the framework offers the robot(s) to the requesting framework. The offer may include, for each robot being offered, information about the robot (e.g., its location, capacity, and configuration) and a cost. The cost may be based on a prior or existing relationship between the frameworks.

If multiple robots are being offered, they may have different costs. The offers may have a default expiration time and/or they may specify an expiration time.

The requesting framework receives the offers (bids) (at S1202, FIGS. 12A-12B) as described above. The framework that made the offer(s)/bid(s) then monitors to determine if any of them are accepted (at S1218). The monitoring continues until either an offer is accepted or the offers expire.

If the requesting framework selects one of this frameworks bids (at S1018), then the framework makes the delivery (at S1220).

Real Time

Those of ordinary skill in the art will realize and understand, upon reading this description, that, as used herein, the term “real time” means near real time or sufficiently real time. It should be appreciated that there are inherent delays in communication/control systems (e.g., based on distances), and these delays may cause delays in data reaching various system components. Inherent delays in the system do not change the real time nature of the data. In some cases, the term “real time data” may refer to data obtained in sufficient time to make the data useful for its intended purpose (e.g., control). Although the term “real time” has been used here, it should be appreciated that the system is not limited by this term or by how much time is actually taken for data to have an effect on control information.

Computing

The applications, services, mechanisms, operations, and acts shown and described above are implemented, at least in part, by software running on one or more computers.

Programs that implement such methods (as well as other types of data) may be stored and transmitted using a variety of media (e.g., computer readable media) in a number of manners. Hard-wired circuitry or custom hardware may be used in place of, or in combination with, some or all of the software instructions that can implement the processes of various embodiments. Thus, various combinations of hardware and software may be used instead of software only.

One of ordinary skill in the art will readily appreciate and understand, upon reading this description, that the various processes described herein may be implemented by, e.g., appropriately programmed general purpose computers, special purpose computers and computing devices. One or more such computers or computing devices may be referred to as a computer system.

FIG. 14 is a schematic diagram of a computer system 1400 upon which embodiments of the present disclosure may be implemented and carried out.

According to the present example, the computer system 1400 includes a bus 1402 (i.e., interconnect), one or more processors 1404, a main memory 1406, read-only memory 1408, removable storage media 1410, mass storage 1412, and one or more communications ports 1414. Communication port(s) 1414 may be connected to one or more networks (not shown) by way of which the computer system 1400 may receive and/or transmit data.

As used herein, a “processor” means one or more microprocessors, central processing units (CPUs), computing devices, microcontrollers, digital signal processors, or like devices or any combination thereof, regardless of their architecture. An apparatus that performs a process can include, e.g., a processor and those devices such as input devices and output devices that are appropriate to perform the process.

Processor(s) 1404 can be any known processor, such as, but not limited to, an Intel® Itanium® or Itanium 2® processor(s), AMD® Opteron® or Athlon MP® processor(s), or Motorola® lines of processors, and the like. Communications port(s) 1414 can be any of an Ethernet port, a Gigabit port using copper or fiber, or a USB port, and the like. Communications port(s) 1414 may be chosen depending on a network such as a Local Area Network (LAN), a Wide Area Network (WAN), or any network to which the computer system 1400 connects. The computer system 1400 may be in communication with peripheral devices (e.g., display screen 1416, input device(s) 1418) via Input/Output (I/O) port 1420.

Main memory 1406 can be Random Access Memory (RAM), or any other dynamic storage device(s) commonly known in the art. Read-only memory (ROM) 1408 can be any static storage device(s) such as Programmable Read-Only Memory (PROM) chips for storing static information such as instructions for processor(s) 1404. Mass storage 1412 can be used to store information and instructions. For example, hard disk drives, an optical disc, an array of disks such as Redundant Array of Independent Disks (RAID), or any other mass storage devices may be used.

Bus 1402 communicatively couples processor(s) 1404 with the other memory, storage and communications blocks. Bus 1402 can be a PCI/PCI-X, SCSI, a Universal Serial Bus (USB) based system bus (or other) depending on the storage devices used, and the like. Removable storage media 1410 can be any kind of external storage, including hard-drives, floppy drives, USB drives, Compact Disc-Read Only Memory (CD-ROM), Compact Disc-Re-Writable (CD-RW), Digital Versatile Disk-Read Only Memory (DVD-ROM), etc.

Embodiments herein may be provided as one or more computer program products, which may include a machine-readable medium having stored thereon instructions, which may be used to program a computer (or other electronic devices) to perform a process. As used herein, the term “machine-readable medium” refers to any medium, a plurality of the same, or a combination of different media, which participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory, which typically constitutes the main memory of the computer. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications.

The machine-readable medium may include, but is not limited to, floppy diskettes, optical discs, CD-ROMs, magneto-optical disks, ROMs, RAMs, erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments herein may also be downloaded as a computer program product, wherein the program may be transferred from a remote computer to a requesting computer by way of data signals embodied in a carrier wave or other propagation medium via a communication link (e.g., modem or network connection).

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols; and/or (iv) encrypted in any of a variety of ways well known in the art.

A computer-readable medium can store (in any appropriate format) those program elements which are appropriate to perform the methods.

As shown, main memory 1406 is encoded with application(s) 1422 that support(s) the functionality as discussed herein (the application(s) 1422 may be an application(s) that provides some or all of the functionality of the services/mechanisms described herein). Application(s) 1422 (and/or other resources as described herein) can be embodied as software code such as data and/or logic instructions (e.g., code stored in the memory or on another computer readable medium such as a disk) that supports processing functionality according to different embodiments described herein.

During operation of one embodiment, processor(s) 1404 accesses main memory 1406 via the use of bus 1402 in order to launch, run, execute, interpret or otherwise perform the logic instructions of the application(s) 1422. Execution of application(s) 1422 produces processing functionality of the service related to the application(s). In other words, the process(es) 1424 represent one or more portions of the application(s) 1422 performing within or upon the processor(s) 1404 in the computer system 1400.

For example, process(es) 1404 may include an AR application process corresponding to AR application 232.

It should be noted that, in addition to the process(es) 1424 that carries(carry) out operations as discussed herein, other embodiments herein include the application 1422 itself (i.e., the un-executed or non-performing logic instructions and/or data). The application 1422 may be stored on a computer readable medium (e.g., a repository) such as a disk or in an optical medium. According to other embodiments, the application 1422 can also be stored in a memory type system such as in firmware, read only memory (ROM), or, as in this example, as executable code within the main memory 1406 (e.g., within Random Access Memory or RAM). For example, application(s) 1422 may also be stored in removable storage media 1410, read-only memory 1408, and/or mass storage device 1412.

Those skilled in the art will understand that the computer system 1400 can include other processes and/or software and hardware components, such as an operating system that controls allocation and use of hardware resources. For example, as shown in FIG. 18, the computer system 1400 may include one or more sensors 1426.

As discussed herein, embodiments of the present invention include various steps or operations. A variety of these steps may be performed by hardware components or may be embodied in machine-executable instructions, which may be used to cause a general-purpose or special-purpose processor programmed with the instructions to perform the operations. Alternatively, the steps may be performed by a combination of hardware, software, and/or firmware. The term “module” refers to a self-contained functional component, which can include hardware, software, firmware or any combination thereof.

One of ordinary skill in the art will readily appreciate and understand, upon reading this description, that embodiments of an apparatus may include a computer/computing device operable to perform some (but not necessarily all) of the described process.

Embodiments of a computer-readable medium storing a program or data structure include a computer-readable medium storing a program that, when executed, can cause a processor to perform some (but not necessarily all) of the described process.

Where a process is described herein, those of ordinary skill in the art will appreciate that the process may operate without any user intervention. In another embodiment, the process includes some human intervention (e.g., a step is performed by or with the assistance of a human).

Although embodiments hereof are described using an integrated device (e.g., a smartphone), those of ordinary skill in the art will appreciate and understand, upon reading this description, that the approaches described herein may be used on any computing device that includes a display and at least one camera that can capture a real-time video image of a user. For example, the system may be integrated into a heads-up display of a car or the like. In such cases, the rear camera may be omitted.

As used herein, including in the claims, the phrase “at least some” means “one or more,” and includes the case of only one. Thus, e.g., the phrase “at least some ABCs” means “one or more ABCs”, and includes the case of only one ABC.

As used in this description, the term “portion” means some or all. So, for example, “A portion of X” may include some of “X” or all of “X”. In the context of a conversation, the term “portion” means some or all of the conversation.

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

It should be appreciated that the words “first” and “second” in the description and claims are used to distinguish or identify, and not to show a serial or numerical limitation. Similarly, the use of letter or numerical labels (such as “(a)”, “(b)”, and the like) are used to help distinguish and/or identify, and not to show any serial or numerical limitation or ordering.

No ordering is implied by any of the labeled boxes in any of the flow diagrams unless specifically shown and stated. When disconnected boxes are shown in a diagram the activities associated with those boxes may be performed in any order, including fully or partially in parallel.

While the invention has been described in connection with what is presently considered to be the most practical and preferred embodiments, it is to be understood that the invention is not to be limited to the disclosed embodiment, but on the contrary, is intended to cover various modifications and equivalent arrangements included within the spirit and scope of the appended claims.

I claim:

1. A method for operating a framework comprising a plurality of robots, the method comprising
receiving a request for a delivery, the request comprising an associated delivery location;
selecting from a subset of the plurality of robots an appropriate robot to handle the delivery; and
executing the delivery,
wherein the selection is based at least on the delivery location and one or more subsequent locations the robot is to reach, and
wherein the appropriate robot is one of the subset of the plurality of robots that has sufficient capacity to execute the request for a delivery and to reach the one or more subsequent locations.

2. The method according to claim 1, wherein
the selection of the appropriate robot is further based on a configuration of the plurality of robots;
the delivery requires a predetermined robot configuration; and
the appropriate robot further has the predetermined robot configuration required for the delivery.

3. The method according to claim 2, wherein the predetermined robot configuration comprises at least one or a combination of:
a robot configured for carrying temperature-sensitive goods;
a robot configured for carrying a plurality of size-appropriate goods as part of distinct deliveries;
a robot configured for carrying a limited number of predetermined goods;
a robot configured for preparing the goods during transport.

4. The method according to claim 1, wherein the plurality of robots comprises a plurality of subsets of robots configured to handle different types of deliveries and wherein the method further comprises, before selecting the appropriate robot, selecting an appropriate subset.

5. The method according to claim 4, wherein the subsets of robots are dynamically updated based on at least one of:
forecasted requests for deliveries; and/or
forecasted deliveries at one or more locations; and/or
prior demand for deliveries; and/or
forecasted future demand for deliveries.

6. The method according to claim 5, wherein the subsets of robots are updated based on at least one of prior and forecasted demand for deliveries requiring a particular robot configuration.

7. The method according to claim 5, further comprising at least one of:
transporting at least one of the plurality of robots to a certain location based on at least one of the forecasting of future demand for deliveries and the forecasting of future demand for deliveries requiring at least one particular robot configuration; and/or
outfitting at least one robot with a predetermined robot configuration based on the forecasting of future demand for deliveries; and/or
loading at least one robot with certain goods based on the forecasting of future demand for deliveries.

8. The method according to claim 5, wherein the forecasting is dynamically updated.

9. The method according to claim 5, wherein the forecasting is performed based on at least one of:
types of delivery requested; and/or
delivery locations; and/or
time of request for deliveries; and/or
day of request for deliveries; and/or
weather conditions at or around the delivery locations; and/or
events at or around the delivery locations.

10. The method according to claim 1, further comprising, in case no appropriate robot can be selected from the subset of the plurality of robots, requesting a robot from at least one other framework to execute the delivery.

11. A delivery framework comprising
a plurality of robots; and
a backend platform comprising at least one processor and at least one database,
wherein the backend platform is configured for:
receiving a request for a delivery, the request comprising an associated delivery location; and
selecting from a subset of the plurality of robots, an appropriate robot to handle the delivery,
wherein the selection is based at least on the delivery location and one or more subsequent locations the robot is to reach;
wherein the appropriate robot is one of the subset of the plurality of robots that has sufficient capacity to execute the request for a delivery and to reach the one or more subsequent locations.

12. The delivery framework according to claim 11, further comprising a frontend platform configured for communication between the framework and users requesting a delivery.

13. The delivery framework according to claim 11, further comprising a robot storage facility comprising at least one of:
a hub; and/or
a pod; and/or
a servicing location; and/or
a robot moving vehicle.

14. The delivery framework according to claim 13, wherein the storage facility is configured to at least one of:
storing the plurality of robots; and/or
maintaining the plurality of robots; and/or
servicing the plurality of robots; and/or
loading the plurality of robots with goods.

15. The delivery framework according to claim 11, wherein each of the plurality of robots comprises a corresponding robot configuration and wherein the robot configuration comprises at least one of:
a robot configured for carrying temperature-sensitive goods; and/or
a robot configured for carrying a plurality of size-appropriate goods as part of different deliveries; and/or
a robot carrying predetermined goods; and/or
a robot configured for preparing the goods during transport.

16. The delivery framework according to claim 11, wherein the backend platform is further configured to forecast demand for deliveries and wherein the forecasting is based on at least one of:
types of delivery requested; and/or
delivery locations; and/or
time of request for deliveries; and/or
day of request for deliveries; and/or
weather conditions at or around the delivery locations; and/or
events at or around the delivery locations.

17. The delivery framework according to claim 16, wherein the backend platform is further configured to determine preferred robot configurations based on the forecasting.

18. A method, in a framework comprising a plurality of robots, the method comprising:
in response to a request for a delivery, said delivery having an associated delivery location,
attempting to select, from a subset of said plurality of robots, an appropriate robot to handle the delivery, said selection being based on said delivery location,
wherein said appropriate robot is one of said plurality of robots that has sufficient capacity to make said delivery.

19. The method of claim 18, wherein said selection is also based on one more possible end locations, and wherein said appropriate robot is one of said plurality of robots that has sufficient capacity to make said delivery and to reach one of said one or more possible end locations.

20. The method of claim 18, wherein said attempting to select is based on a configuration of said robots and wherein said delivery has a delivery type and wherein said attempting to select is based on said delivery type.

21. The method of claim 18, wherein the delivery requires a pickup associated with said delivery at at least one pickup location, and wherein said attempting to select is based on said at least one pickup location, and wherein said appropriate robot is one of said plurality of robots that has sufficient capacity to make said pickup at at least one pickup location, and to make said delivery, and to reach one of said one or more possible end locations.
